(19) United States
(12) Patent Application Publication
(10) Pub. No.: US 2013/0069820 A1
(43) Pub. Date: Mar. 21, 2013

(54) Apparatus and Methods for Satellite Communication

(71) Applicant: Gregory Thane Wyler, Sewall's Point, FL (US)

(72) Inventor: Gregory Thane Wyler, Sewall's Point, FL (US)

(21) Appl. No.: 13/528,613

(22) Filed: Jun. 20, 2012

Related U.S. Application Data
(63) Continuation of application No. 12/761,902, filed on Apr. 16, 2010, now abandoned.
Application No. 12/761,902 is a continuation of application No. PCT/US08/75372, filed on Sep. 5, 2008.
Application No. PCT/US08/75372 is a continuation-in-part of application No. PCT/US07/81763, filed on Oct. 18, 2007.
Application No. PCT/US07/81763 is a continuation-in-part of application No. PCT/US08/63853, filed on May 16, 2008.

(51) Int. Cl. H04B 7/204

(52) U.S. Cl. CPC H04B 7/2041
USPC 342/354

(57) ABSTRACT

A communications system and method are disclosed that may include a constellation of satellites operating in a substantially equatorial, non-geostationary orbit; a plurality of ground stations configured to communicate with the satellites, at least one given ground station of the ground stations lacking a wired connection to any global communications network; and at least one gateway station coupled to a global communications network and to at least one said satellite, wherein each satellite includes at least one antenna having a steerable beam, the antenna being controllable to continuously direct a concentrated spot beam toward the given ground station.

### CROSS-REFERENCE TO RELATED APPLICATIONS

This application is a Continuation of PCT Application Serial No. PCT/US08/75372, filed Sep. 5, 2008, entitled “APPARATUS AND METHODS FOR SATELLITE COMMUNICATION” [Attorney Docket 790-5-PCT], published as Pub. No. WO 2009/051907 on Apr. 23, 2009, and this application is a Continuation-In-Part of PCT Application Serial No. PCT/US07/81763, filed Oct. 18, 2007, entitled “SYSTEM AND METHOD FOR SATELLITE COMMUNICATION” [Attorney Docket 790-2-PCT], published as Pub. No. WO 2009/51592 on Apr. 23, 2009; and this application is a Continuation-In-Part of PCT Application Serial No. PCT/US08/63853, filed May 16, 2008, entitled “SYSTEMS AND METHODS FOR SATELLITE COMMUNICATION” [Attorney Docket 790-4-PCT], published as Pub No. 2009/139778 on Nov. 19, 2009, all of which applications are hereby incorporated herein by reference in their entirety.

### BACKGROUND OF THE INVENTION

The present invention relates in general to communication systems and in particular to systems and methods for satellite-based communication.

Satellite communication systems provide various benefits to consumers of communication services such as for telephony, internet communications, television communications among others. Various satellite systems are currently available, which are discussed below.

Satellites employing a geostationary (GEO) orbit provide the convenience of having one or more satellites in such a system remain fixed in relation to the earth as the earth rotates. However, at the GEO orbit altitude, which is about 36,000 kilometers (km), communication latency is about 600 milliseconds (ms). Such latency leads to very slow communication throughput and is particularly ineffective for Internet communication. For example, the main page at “www.cnn.com”® might take up to 24 seconds to load with this latency period in effect.

For this reason, and others, satellites employing non-geostationary orbits (NGSOs), such as medium earth orbit (MEO), (between 2000 and 36000 km) and low earth orbit (LEO) (below 2000 km), have in certain cases, been used instead. The existing LEO and MEO satellite systems typically employ inclined orbits to enable such systems to reach high concentrations of customers located in the northern and southern hemispheres. In such orbits, the satellites move continuously with respect to various ground stations with which satellites communicate. Moreover, successive satellites in such constellations commonly move along different orbital planes. Thus, many such systems employ omni-directional antennas at earth-based user terminals to enable ongoing communication to take place as the various satellites in a constellation move through their respective orbits. However, such omni-directional antennas tend to have very low gain, thereby limiting the communication throughput (communication bandwidth) achievable using this approach. One way to compensate for the low gain level of the antennas at the user terminal is to significantly increase the power used for satellite antenna transmission. However, such increased satellite transmission power levels may exceed the power available using current satellite power generation technology, and are therefore impractical.

Additionally, satellites traveling in NGSO orbits may cause interference between one or more entities within a GEO satellite communication system. Accordingly, transmission activity by NGSO satellites is commonly interrupted when NGSO satellites get too close to a communication path between a GEO satellite and a ground station in communication with the GEO satellite. Such interruptions may impose significant inconvenience and expense on the operation of NGSO satellite systems.

Accordingly, there is a need in the art for satellite communication systems providing effective communication service at a reduced cost and which avoid interfering with existing satellite systems.

### SUMMARY OF THE INVENTION

According to one aspect, the present invention is directed to a communications system that may include a constellation of satellites operating in a substantially equatorial, non-geostationary orbit around the earth, wherein at least one satellite includes a first antenna controllable to direct a first concentrated spot beam to at least one ground station; and a second antenna controllable to direct a second concentrated spot beam to at least one gateway ground station. Preferably, the at least one satellite is operable to establish a communication path between the ground station and the gateway station along the first and second spot beams. Preferably, at least one of the first antenna and the second antenna is mechanically steerable. Preferably, at least one of the first antenna and the second antenna is an electronically steerable antenna, such as a phased array antenna. Preferably, the at least one satellite is operable to avoid interference with GEO satellite communication with a GEO sub-satellite point on the earth, by communicating with ground stations on the earth having a minimum latitudinal angular separation from the GEO sub-satellite point. Preferably, the minimum latitudinal angular separation is about 5 degrees.

Preferably, the system is operable to avoid interference with GEO satellite communication with a GEO sub-satellite point on the earth, by using a satellite within the constellation of satellites having a sub-satellite point having a minimum longitudinal angular separation from the GEO sub-satellite point. Preferably, the minimum longitudinal angular separation is about 5 degrees. Preferably, a plurality of the satellites in the constellation are within a communication range of the ground station at any given time, thereby providing redundant satellite communication options for the ground station. Preferably, the ground station is operable to hand off communication from a first satellite to a second satellite in the event of a failure of the first satellite. Preferably, the constellation includes at least 16 satellites and wherein at least 3 satellites are within a communication range of the ground station at any given time. Preferably, the at least one ground station lacks a wired connection to any global communications network, and wherein the at least one gateway station has a wired connection to a global communications network.

Preferably, the global communications network includes the Internet. Preferably, the at least one satellite is operable to route data packet signals to a destination within the communications system based on a transmission frequency of the data packet signal. Preferably, the constellation of satellites operates in an orbit having an altitude between about 2,000 kilometers (km) and about 25,000 km. Preferably, the constellation of satellites operates in an orbit having an altitude between about 8,000 kilometers (km) and about 20,000 km.

According to another aspect, the invention is directed to a method that may include causing a constellation of satellites to travel along a substantially equatorial, non-geostationary orbit; controlling a first antenna aboard at least one satellite to direct a first concentrated spot beam to at least one ground station; and controlling a second antenna on the at least one satellite to direct a second concentrated spot beam to at least one gateway station. Preferably, the method further includes establishing a communication path between the ground station and the gateway station along the first and second spot beams. Preferably, the step of controlling the first antenna comprises at least one of: a) mechanically steering the first antenna to direct the first concentrated spot beam to the at least one ground station; and b) electronically steering the first concentrated spot beam.

Preferably, the step of controlling the second antenna comprises at least one of: a) mechanically steering the second antenna to direct the second concentrated spot beam to the at least one ground station; and b) electronically steering the second concentrated spot beam. Preferably, at least one of the first antenna and the second antenna is a phased array antenna. Preferably, the method further includes avoiding interference with communication between a GEO satellite and its GEO sub-satellite point on the earth, by having at least one satellite communicate only with ground stations on the earth having a minimum latitudinal angular separation from the GEO sub-satellite point.

Preferably, the minimum latitudinal angular separation is about 5 degrees. Preferably, the method further includes avoiding interference with communication between a GEO satellite and a sub-satellite point of the GEO satellite by using a satellite within the constellation of satellites, for communication with the ground station, having a sub-satellite point having a minimum longitudinal angular separation from the GEO sub-satellite point. Preferably, the minimum longitudinal angular separation is about 5 degrees.

According to another aspect, the invention is directed to a communications system that may include a constellation of satellites operating in a substantially equatorial, non-geostationary orbit; a plurality of ground stations configured to communicate with the satellites, at least one given ground station of the ground stations lacking a wired connection to any global communications network; and at least one gateway station coupled to a global communications network and to at least one satellite, wherein each satellite includes at least one antenna with a steerable beam controllable to continuously direct a first concentrated spot beam toward the given ground station. Preferably, the at least one antenna includes a mechanically steerable antenna. Preferably, the at least one antenna includes a phased array antenna. Preferably, each satellite is operable to communicate simultaneously with the given ground station, and the at least one gateway station to enable connectivity between the given ground station and the global communications network.

Preferably, the global communications network includes the Internet. Preferably, the given ground station is configured to transfer communication connectivity from a first satellite of the constellation to a succession of satellites entering a communication range of the given ground station, thereby providing substantially continuous communication connectivity of the given ground station to the global communications network. Preferably, the orbit of the satellite constellation has an altitude of between about 2,000 km and about 25,000 km. Preferably, the orbit of the satellite constellation has an altitude of between about 6,000 km and about 20,000 km. Preferably, the orbit of the satellite constellation has an altitude of between about 7,000 km and about 12,000 km.

Other aspects, features, advantages, etc. will become apparent to one skilled in the art when the description of the preferred embodiments of the invention herein is taken in conjunction with the accompanying drawings.

### BRIEF DESCRIPTION OF THE DRAWINGS

For the purposes of illustrating the various aspects of the invention, there are shown in the drawings forms that are presently preferred, it being understood, however, that the invention is not limited to the precise arrangements and instrumentalities shown.

FIG. 1 is a block diagram of a communication system including a satellite system in accordance with one or more embodiments of the present invention;

FIG. 2 is a block diagram of connections between the satellite system of FIG. 1 with a plurality of respective ground stations and respective groups of local subscribers, in accordance with one or more embodiments of the present invention;

FIG. 3 is a block diagram of a portion of a communication system in accordance with one or more embodiments of the present invention;

FIG. 3A is a block diagram of a portion of computing system that may be deployed in communication with at least one ground station of the system of FIG. 3;

FIG. 4 is a perspective view of a constellation of satellites in an equatorial orbit about the earth in accordance with an embodiment of the present invention;

FIG. 5 is a plan view of a constellation of satellites in orbit around the earth in accordance with one or more embodiments of the present invention;

FIG. 6 is a plan view of a constellation of satellites in orbit around the earth, showing self-healing capabilities of one or more embodiments of the present invention;

FIG. 7 is a schematic view of a north-south sectional plane of the earth being orbited by a GEO satellite and a satellite forming part of a non-GEO satellite system in accordance with an embodiment of the present invention;

FIG. 8 is a schematic view of an equatorial plane of the earth being orbited by a GEO satellite and a satellite forming part of a non-GEO satellite system in accordance with an embodiment of the present invention;

FIG. 9 is a schematic view of an equatorial plane of the earth being orbited by a GEO satellite and two satellites forming part of a non-GEO satellite system in accordance with an embodiment of the present invention;

FIG. 10 shows a longitude range along the perimeter of the earth visible to a satellite orbiting the earth in accordance with one or more embodiments of the present invention;

FIG. 11 is a view of a Mercator projection map of a portion of the earth showing a selection of satellites orbiting the earth in accordance with one or more embodiments of the present invention;

FIG. 12 is a schematic plan view of a satellite forming part of a constellation traveling along an equatorial orbit over South America in accordance with an embodiment of the present invention;

FIG. 13 is a schematic plan view of two satellites forming part of a constellation traveling along an equatorial orbit over South America in accordance with an embodiment of the present invention;

FIG. 14 is a schematic plan view of the two satellites of FIG. 13 having advanced along their orbit in accordance with an embodiment of the present invention;

FIG. 15 is a functional block diagram of hardware aboard a satellite in accordance with one or more embodiments of the present invention;

FIG. 15A is a schematic representation of equipment aboard a satellite in accordance with one or more embodiments of the present invention;

FIG. 16 is a block diagram showing a plurality of communication dishes on a satellite in accordance with one or more embodiments of the present invention;

FIG. 17 is a schematic representation of a satellite having two mechanically steerable antennas in accordance with one or more embodiments of the present invention;

FIG. 18 is a schematic representation of a satellite having two electronically steerable antennas in accordance with one or more embodiments of the present invention; and

FIG. 19 is a block diagram of a computer system adaptable for use with one or more embodiments of the present invention.

### DETAILED DESCRIPTION OF THE PREFERRED EMBODIMENTS

In the following description, for purposes of explanation, specific numbers, materials and configurations are set forth in order to provide a thorough understanding of the invention. It will be apparent, however, to one having ordinary skill in the art that the invention may be practiced without these specific details. In some instances, well-known features may be omitted or simplified so as not to obscure the present invention. Furthermore, reference in the specification to phrases such as “one embodiment” or “an embodiment” means that a particular feature, structure or characteristic described in connection with the embodiment is included in at least one embodiment of the invention. The appearances of phrases such as “in one embodiment” or “in an embodiment” in various places in the specification do not necessarily all refer to the same embodiment.

Those skilled in the art will appreciate the fact that antennas, which may include beamformers, and/or may include equipment for communicating over optical links which communicate either with other satellites or with ground stations, are reciprocal transducers which exhibit similar properties in both transmission and reception modes. For example, the antenna patterns for both transmission and reception are generally identical and may exhibit approximately the same gain. For convenience of explanation, descriptions are often made in terms of either transmission or reception of signals, on the understanding that the pertinent description applies to the other of the two possible operations. Thus, it is to be understood that the antennas of the different embodiments described herein may pertain to either a transmission or reception mode of operation. Those of skill in the art will also appreciate the fact that the frequencies received and/or transmitted may be varied up or down in accordance with the intended application of the system.

One or more embodiments of the present invention address the various limitations of existing systems by providing a constellation of satellites traveling in a substantially equatorial LEO or MEO orbit that is operable to serve as a communication intermediary between ground stations that are not connected to any wired network, and gateway stations that provide a link to essentially an entirety of the wired, global communication network. The communication concerned may be used for Internet service, mobile phone service, locally wired telephone service, and/or satellite television, among others.

In an embodiment, the concentration and distribution of satellites within the constellation is preferably established so as to allow the constellation to effectively serve as an airborne equatorial communications trunk line providing continuous bandwidth availability to all regions within its service range. Notably, many of the areas most effectively served by embodiments of the present invention are located in developing, tropical (including equatorial), parts of the world that currently do not have fiber or other wired connectivity to the Internet or other wired global communications system. Thus, for such currently unwired regions, various embodiments of the present invention present the only available solution with which to address the current lack of high-speed communication. For less isolated regions, having substantially saturated wired connectivity, embodiments of the present invention still present a beneficial second source of high-speed data connectivity.

Embodiments of the present invention provide much reduced communication latency in comparison with GEO satellite systems. For earth stations at the equator, the distance to a GEO satellite is 36,000 km, thus 3.6×10⁷ m (meters). In one embodiment, the distance from the earth station on the equator to a satellite in an equatorial medium earth orbit (at an altitude of 8,000 km) is clearly 8000 km (8×10⁶ m). The latency due to data transmission for the GEO satellite, for one round trip (one trip from earth to satellite, and one trip from satellite to ground) is therefore 3.6×10⁷ m /3.0×10⁸m/s)×2=0.240 seconds, or 240 milliseconds (msec). A satellite round trip time (RTT) from a hub-based system requires two hops (up and down from the remote terminal to the hub and then up and down from the hub back to the remote terminal), and would thus incur a transmission time of 480 msec. With a MEO satellite in an 8000 km orbit, the one hop latency for earth terminals at the equator, the latency would be (8×10⁶ /3×10⁸)×2=0.053 sec or 53 msec. A full round trip (a trip from earth to the satellite and back again) time would thus be 106 msec. The latency reduction for MEO satellites vs. GEO satellites is thus considerable.

For earth stations at latitudes other than the equator, the same relationship holds. For example, the distance from an for an earth station at approximately 40° N latitude to a GEO satellite is about 38,600 km, and the distance from this same earth station to a satellite in an equatorial MEO orbit is about 10,500 km. Applying the formula above, the RTT latency to the GEO satellite from an earth station at 40° N latitude would be about 515 msec., and the RTT latency to a satellite in an equatorial MEO orbit from an earth station at 40° N latitude would be 140 msec. Other factors may contribute to communication latency such as processing time in computers (either at earth stations or in satellites) or routers. However, the dominant factor is the distance to and from the satellite. From the above, it may be seen that the orbit altitudes of various embodiments of the present invention are operable to substantially reduce communication latency.

Moreover, the at least substantially equatorial orbit contemplated by various embodiments herein operates to simplify the process of ensuring that satellites and ground stations orient their respective satellite dishes toward one another during periods of communication with one another. Further, suitable selection of the number of satellites in each constellation (one or more constellations may be employed), of the geocentric angle separating successive satellites within a constellation enable avoiding interference communication paths between GEO satellites and ground stations communicating with the GEO satellites.

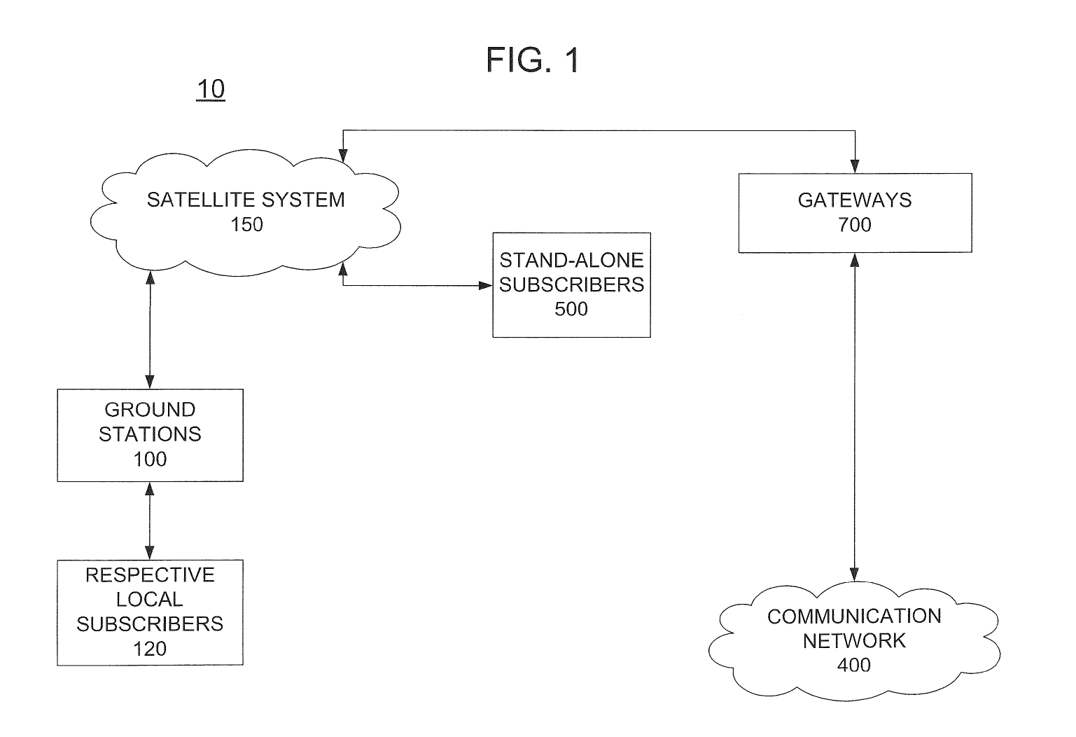

FIG. 1 is a block diagram of a communication system 10 including a satellite system 150 in accordance with one or more embodiments of the present invention. Communication system 10 may include ground stations 100, which may be coupled to local subscribers 120; satellite system 150, stand-alone subscribers 500; communication gateways (gateway stations) 700; and communication network 400. The portions of system 10 identified above are described further below.

Communication network 400 may be a ground-based network that may include the Internet. However, communication network 108 may refer to any communications network or system, or combination of such networks, capable of employing a satellite communications system to enable communication between one or more ground stations 106 with a network 400 and/or with each other. Such systems may include, either in place of or in addition to the Internet, telephone systems (landline and/or wireless), radio communications (one-way broadcast and/or two-way radio), television broadcasting, international warning system broadcast (such as for weather emergencies or other event), and/or other communication systems.

Gateway stations 700 may serve as communication intermediaries between one or more satellites and one or more ground-based communication networks, which may be wired or wireless. Herein, gateways 700 may serve as interfaces between communication network 400 and satellite system 150. Gateway stations 700 may include one or more gateway stations or gateway terminals for receiving/transmitting data for retransmission to satellite system 150 and/or communication network 108. Gateway stations 700 could be land-based and may provide any needed data communication routing and/or data format conversion needed to enable communication between communication network 150 and satellite system 700. For instance, gateway stations 700 may include controllers and/or other control means for controlling the location of a data communication path, such as by selecting one or more satellites from among a plurality of satellites to conduct data communication with and/or selecting one or more transponders on one satellite or distributed over a plurality of satellites for conducting data communication. In some respects, a gateway station 700 may be considered to be a special-purpose ground station. However, in other embodiments, one or more gateway stations 700 may be satellites serving as intermediary transceiving stations a) between a satellite and a ground station; b) between two satellites; and/or c) between two ground stations.

Herein, the terms “satellite system 150” and “satellites 150” are used interchangeably and generally refer to the totality of satellites employed as communication intermediaries in between gateway stations 700 and ground stations 100, and/or stand-alone subscribers 500. Satellite system 150 may include one or more satellite constellations, and each constellation may include one or more satellites. Thus, satellite system 150 may include any number of satellites 200 from one up to any desired number. Each satellite 200 of satellite system 150 may receive data from gateway 700 and retransmit such data either directly or via another satellite to one or more specified ground stations 100, any other satellite 200, any stand-alone subscriber 500, within satellite system 150. Conversely, satellite system 150 may receive data from one or more ground stations 106 and/or one or more stand-alone subscribers 500 and retransmit the received data to one or more gateway stations 700.

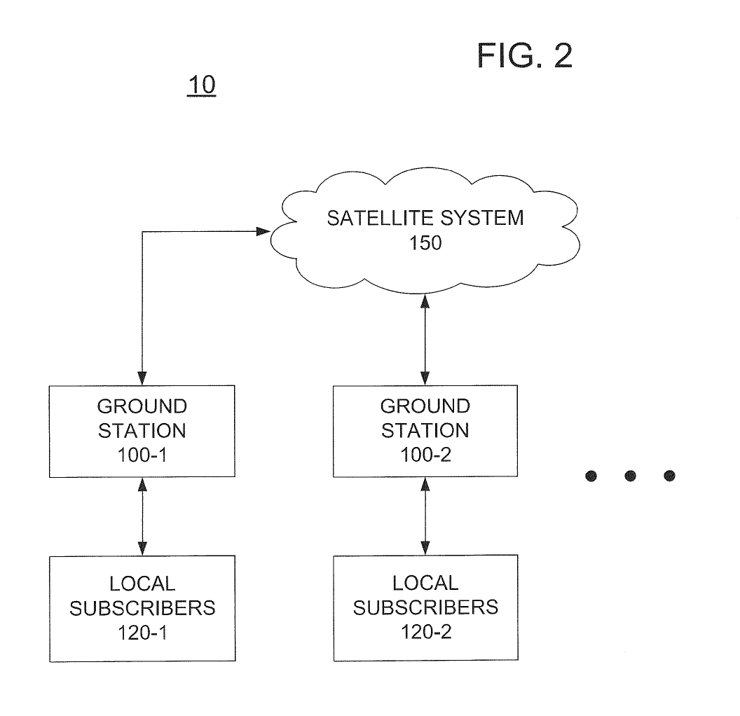

Ground stations 100 may be established in substantially permanently fixed locations and serve as communications hubs for networks of respective groups of local subscribers 120, as shown in FIG. 2. In other embodiments, ground stations 100 may be mobile. For example, a ground station 100 may be implemented on a truck, trailer, or other vehicle capable of carrying and powering antenna systems capable of communicating with one or more satellites. Alternatively, a mobile ground station could be a semi-permanent platform, which is nevertheless moveable with suitable equipment when desired. Mobile ground stations 100 could be useful, for example, for providing information resources and communication to schools, hospitals and the like, in circumstances where such institutions cannot afford permanent ground stations at their respective locations.

Each ground station 100 may be connected to one or more local subscribers 120, which may also be referred to as customer sites. Each subscriber may include one or more user terminals. The nature and communication bandwidth needs of the subscribers may vary widely. For instance, each subscriber may include one or more telephone companies, one or more Internet service providers, one or more Internet cafés, one or more individual communications customers, and/or other form of communication provider such as a cable television provider, or any combination of the foregoing.

Stand-alone subscribers 500 may be subscribers that communicate directly with a satellite 200 of satellite system 150 without employing a ground station 100 as an intermediary. This approach may be suitable where only a subscriber 500 is substantially isolated from other subscribers (such as subscribers 120), and establishment of a local network coupled to a ground station 100 is not cost effective. Herein, the term user station may refer to either a ground station, or a stand-alone subscriber (customer) on the earth.

FIG. 1 depicts a configuration which may be employed by satellites operating at any desired orbit around the Earth, including GEO (Geo-Stationary Orbit), Medium Earth Orbit (MEO), Highly Elliptical Orbit (HEO), or Low Earth Orbit (LEO). GEO occurs at an altitude of about 36,000 kilometers (km). Elliptical orbits refer to orbits in which the satellite altitude above the surface of the earth varies as a function of the angular position of the satellite along its orbit. HEO refers to elliptical orbits in which the distance of the satellite from the earth varies substantially as a function of time, or otherwise stated, with advancement of the satellite along its orbit. Moreover, system 10 may enable communication between different ground stations using a single satellite 200 of satellite system 150 as an intermediary between the ground stations. Alternatively, two or more satellites 200 of satellite system 150 may communicate with respective ground stations 100 that are in the respective communication ranges of the two satellites. In this situation, gateway station 700 may communicate with the two satellites to enable communication between the two satellites, and thus between the two ground stations 106.

Alternatively, two satellites may serve as successive intermediaries between two ground stations, where no single satellite has a line-of-sight connection with both of the ground stations at the same time. Thus, for example, with reference to FIG. 2, the following sequences of links from a first ground station to a second ground station could be implemented. In one embodiment, the link could extend from a first ground station 100-1, to a satellite 200 of satellite system 150, to a second ground station 100-2, and then to final destination at a local subscriber 120-2. In another embodiment, the link could extend from a first ground station, to a first satellite, then to a second satellite, then to the second ground station, and then to a termination point at a customer site. In other embodiments, any number of satellites could be employed as intermediaries between ground stations in communication with one another.

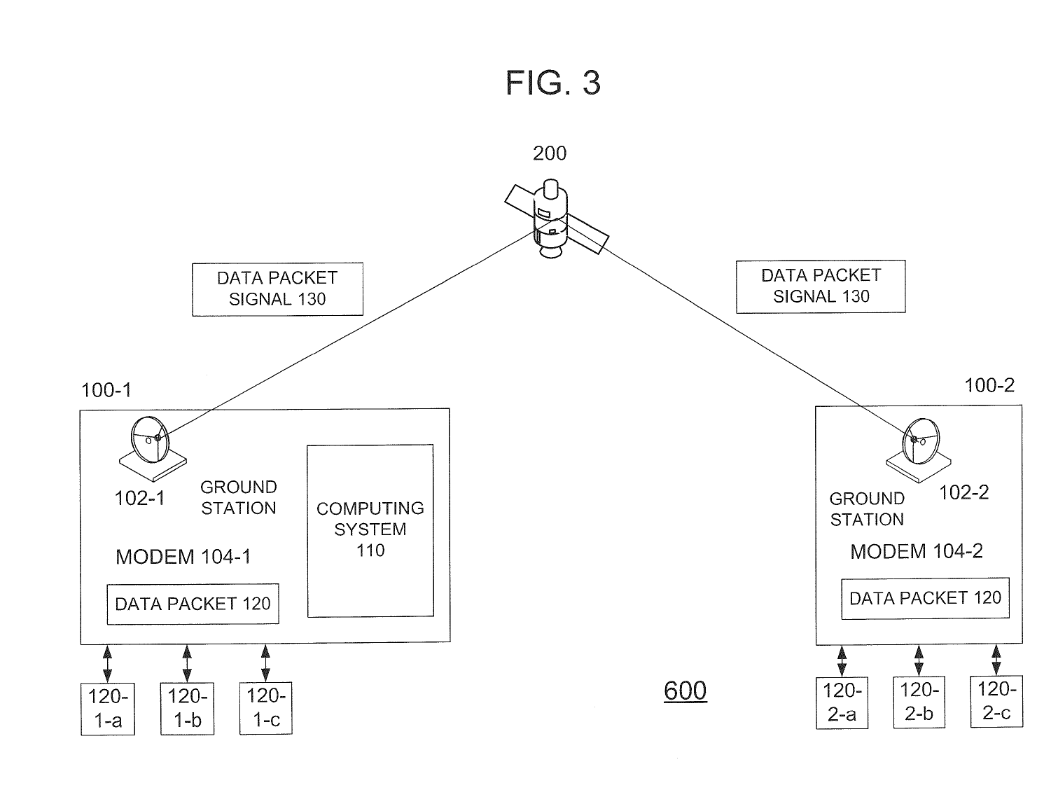

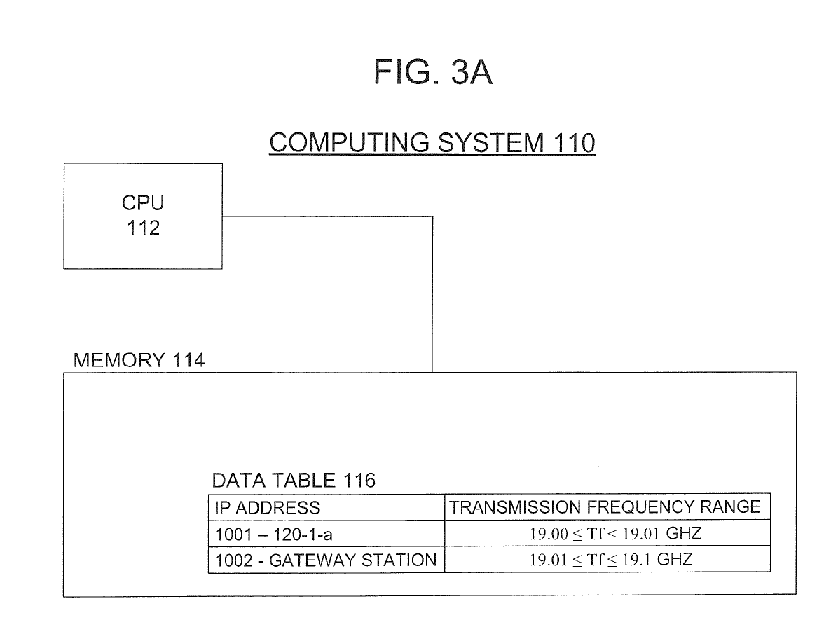

FIG. 3 is a block diagram of a portion of a communication system 10 in accordance with one or more embodiments of the present invention. The portion of communication system 10 shown in FIG. 3 may include satellite 200 and ground stations 100-1 and 100-2 on Earth 600. Since ground stations 100-1 and 100-2 are both coupled to equivalent sets of devices, for the sake of brevity, only the devices coupled to ground station 100-1 are discussed below. Ground station 100-1 may include dish 102-1, modem 104-1, computing system 110, which is shown in greater detail in FIG. 3A. Moreover, ground station 100-1 may be in communication with local subscribers 120-1-a, 120-1-b, and 120-1-c. Ground station 100-2 may include and be in communication with a set of devices paralleling that discussed above for ground station 106-a, as shown in FIG. 3. Dish 102-1 may be any suitable telecommunications dish (also known as a satellite dish). Dish 102-1 may be configured to track satellite 200 as satellite 200 proceeds along an orbit above ground station 100-1. While only one dish 102-1 is shown, any number of dishes may be deployed at ground station 100-1, or other ground station within communication system 10. In one embodiment, two dishes 102 may be deployed at each ground station 100 which may operate in a round robin manner, to enable ground station 100 to hand off communication with satellite system (satellite constellation) 150 from one dish 102 to another, in a round robin manner, as a first satellite 200 proceeds out of range of ground station 100, and a second satellite gradually enters the range of ground station 106. In another embodiment, there may be two satellites 200 serving as successive connections along a data communication link between ground stations 100-1 and 100-2, wherein the signal path passes through the two satellites 200 and wherein the data transmission means employed between the two satellites may include optical transmission and/or radio frequency transmission.

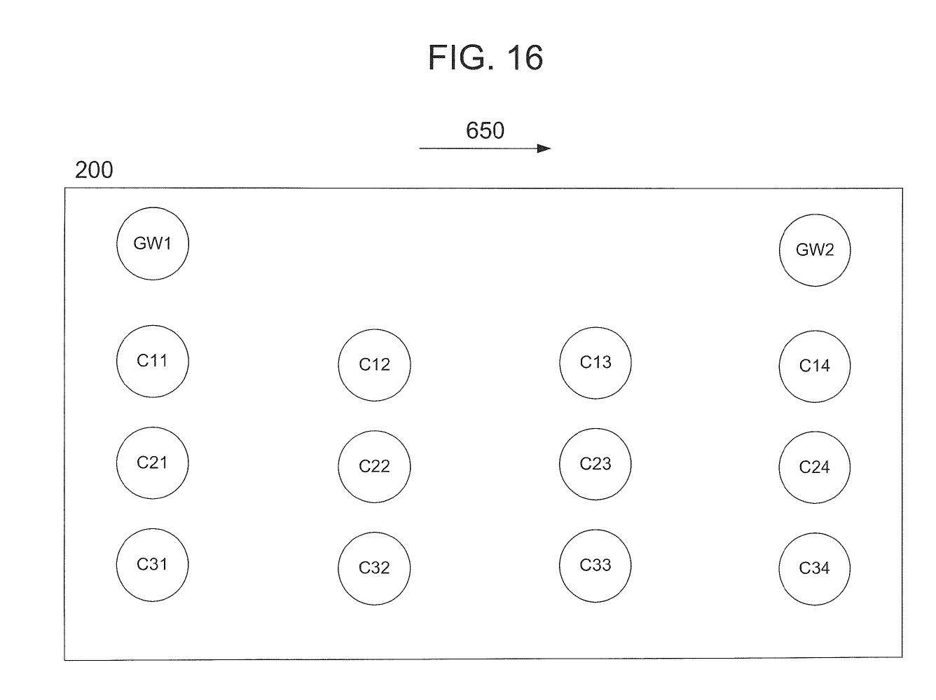

FIG. 3A is a block diagram of a portion of computing system 110 that may be deployed at, and/or be in communication with, ground station 100-1 of FIG. 3. Computing system 110 may include all features needed to control all parts of ground station 100-1, such as the computer components shown in FIG. 16. However, for the sake of brevity, only a subset of the portions of computing system 110 are shown in FIG. 3A. Computing system 110 may include CPU 112 and memory 114. Data table 116 may be stored in memory 114 and may store data associating destination IP addresses of digital data packets with respective transmission frequencies. For the sake of illustration, FIG. 3A shows a simplified version of data table 116. Data table 116 includes simplified IP addresses 1001 and 1002, which correspond to customer site 120-1-a and gateway station 700, respectively. It will be appreciated that in actual implementations, IP addresses may be presented in any format suitable for the pertinent application. Moreover, any number of IP addresses and associated transmission frequencies and/or transmission frequency ranges may be stored in data table 116. While the description herein discusses listing destination IP addresses in table 116, in other embodiments, address data stored in table 216 may include destination IP addresses, origination IP addresses, the IP addresses one or more intermediate points along a data communication path for a data packet, an origination MAC address and/or a destination MAC address.

In an embodiment, at ground station 100-1 (and/or at other comparably configured ground stations within communication system 10), computing system 110 may read the destination IP address of each digital data packet 120, access table 116 within memory 214, and retrieve the transmission frequency corresponding to the IP address read from the digital data packet 120. Thereafter, ground station 106-a may convert digital data packet 120 into analog data packet signal 130 and transmit the data packet signal 130 using the transmission frequency retrieved from data table 216. Herein, the terms “packet” or “data packet” may refer to either digital data packet 120 or analog data packet signal 130. Herein, analog data packet signal 130 is preferably an analog waveform or signal that contains the digital packet information of data packet 120 and that is used to transmit the digital packet information over an analog communications channel.

Data table 116 shows exemplary permissible frequency ranges that may be used for the respective IP addresses. Ground station 100-1 may transmit each packet signal 130 using a transmission frequency anywhere within the transmission frequency range retrieved from data table 116 for a particular IP address. In some embodiments, the transmission frequency ranges of table 216 may be sub-divided into still smaller segments such that each segment of each range corresponds to a specific point of origin of each digital data packet 120.

The association of a frequency range, instead of merely a single frequency, with a given IP address, may be helpful in establishing frequency division thresholds aboard satellite 200 to enable routing data packet signals 130 based on the transmission frequencies of the signals 130. This approach may beneficially avoid having to demodulate the signals 130 (onboard satellite 200), and employ expensive equipment on satellite 200 to route the signals 130 based on digital routing data embedded in the signals.

Routing mechanisms, such as frequency dividers, may be deployed within satellite 200 for routing analog packet signals 130 through the satellite 200. The transmission frequency ranges, such as those shown in table 116, corresponding to the respective IP addresses, may be employed to set thresholds in the frequency dividers in order to implement routing decisions aboard satellite 200 that are consistent with the data in table 116 and that are consistent with the manner in which transmission frequencies were selected for each packet signal 130 prior to being transmitted from ground station 100-1 to satellite 200. Thus, for instance, in accordance with this embodiment, a packet signal 130 received at satellite 200 having a transmission frequency of 19.05 GHz (see FIG. 2A) will preferably be routed by satellite 200 so as to be directed to IP address 1002, which in this case corresponds to gateway station 700.

Considering another example, satellite 200 may serve as an intermediary for communication between ground station 100-1 and 100-2 of FIG. 3. Thus, for example, a digital data packet 120 may be transmitted from customer site 120-1-a to customer 120-2-a through ground station 100-2. Suitable equipment (such as, but not limited to, modem 104-1 and/or computing system 110) at ground station 100-1 may then read the destination IP address of the digital data packet 120 and select a transmission frequency based on the destination IP address of that digital data packet 120. The digital data packet 120 may then be modulated by modem 104-1 to provide analog data packet signal 130 that is the analog version of the digital data packet 120. The analog data packet signal 130 may then be transmitted from ground station 100-1 to satellite 200 using the selected transmission frequency.

Satellite 200 preferably receives the data packet signal 130 and preferably determines the transmission frequency of the received signal (data table establishing this correspondence is not shown). Satellite 200 then preferably routes the data packet signal 130 to an output transponder (satellite dish) on satellite 200 that is selected based on the transmission frequency of the received data packet signal 130. Satellite 200 then preferably retransmits the data packet signal 130 out of the transponder along the intended path, which in this case leads to ground station 100-2. It is assumed for this example that the destination IP address identifies customer site 120-2-a as its final destination. Thus, once the data packet signal 130 is received at ground station 100-2, modem 104-2 preferably demodulates the signal back into digital data packet 120, and identifies the destination IP address. Ground station 100-2 then preferably transmits the digital data packet 120 to customer site 120-2-a.

In the above example, satellite 200 serves as an intermediary between ground stations 100-1 and 100-2, each of which may be coupled to multiple local subscribers. However, satellite 200 may also be in communication with two or more ground-based communication stations of any suitable type. For instance, in other embodiments, satellite 200 may be an intermediary between a ground station and a gateway station, or between two gateway stations. Moreover, each satellite 200 may communicate with one or more satellites and/or with one or more ground stations.

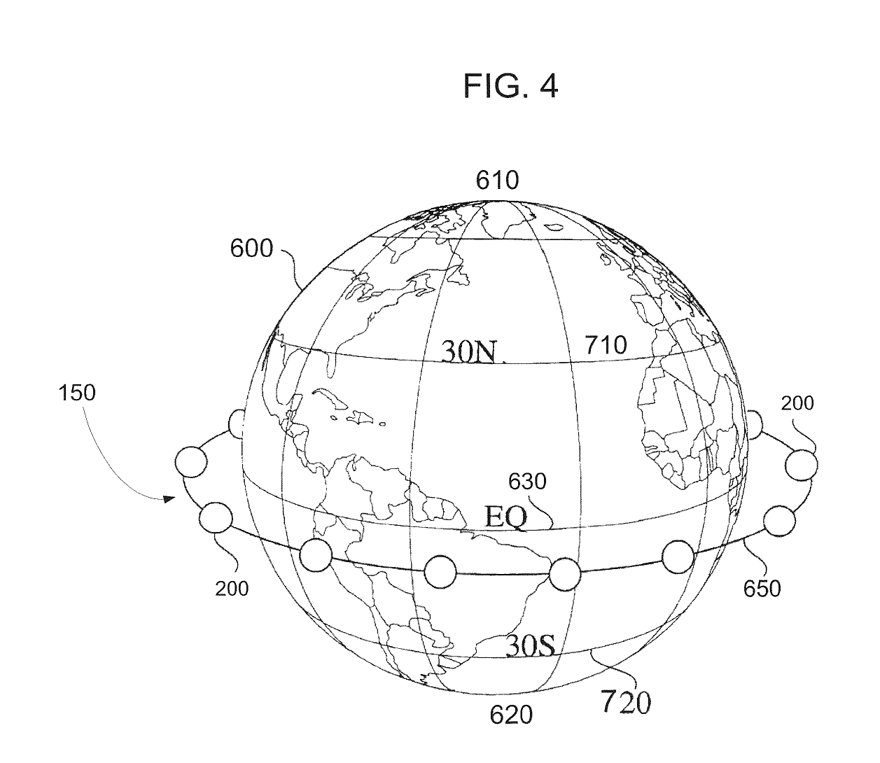

FIG. 4 is a perspective view of a constellation 150 of satellites 200 in an equatorial orbit 650 about the earth 600 in accordance with an embodiment of the present invention.

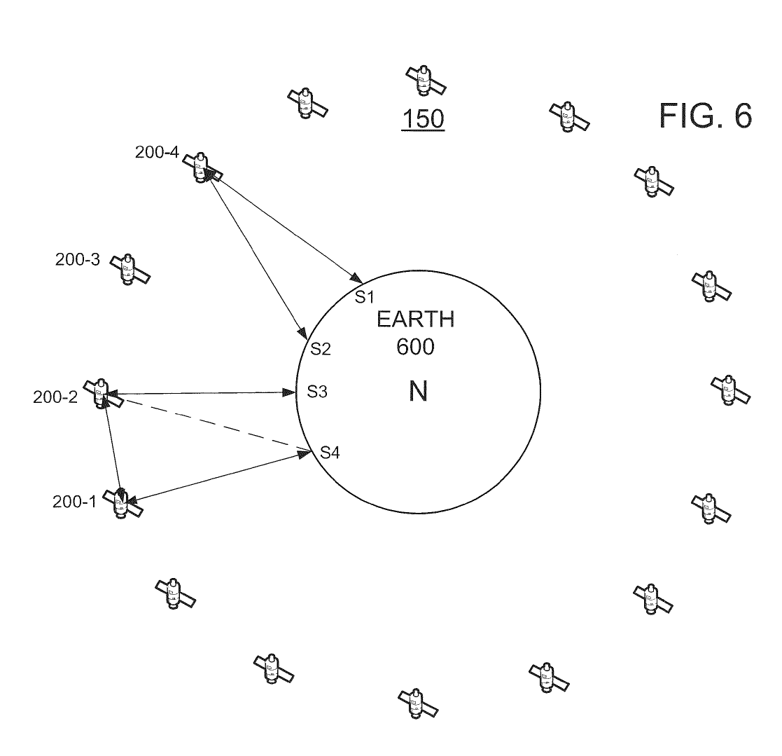

FIG. 4 provides a perspective view of earth 600 having North Pole 610, South Pole 620, equator 630 (also designated with “EQ”) 30 degree north latitude line 710, and 30 degree south latitude line 720. This embodiment of satellite constellation 150 may include sixteen satellites 200 traveling (from left to right in the view of FIG. 4) along orbit 650, which is preferably equatorial. Since only about one half of the earth 600 is visible in the view of FIG. 6, only about eight whole satellites are shown in FIG. 6, although portions of additional satellites are visible. Herein, the point on the earth 600 vertically under a given satellite is the sub-satellite point for that satellite.

Though one constellation of sixteen satellites is shown in FIG. 4, many other embodiments may be implemented. Specifically, any number of constellations may be employed from one to infinity, with each constellation having any desired number of satellites. While the embodiment of FIG. 4 includes sixteen satellites, in other embodiments as few as five satellites may be employed and provide full coverage to all service areas on the earth 600. In other embodiments, any number of satellites from five up to any desired number may be included within satellite system 150.

FIG. 4 shows an orbit 650 that is equatorial, however the invention is not limited to this embodiment. Orbits with varying degrees of inclination may be also be employed. Specifically, in an embodiment, satellites 200 may travel in inclined orbits that fluctuate from 0 to 10 degrees latitude from the equator. In other embodiments, even more inclined orbits may be used, in which satellites 200 travel further than 10 degrees latitude from the equator. In one or more embodiments, satellites 200 traveling in a substantially equatorial orbit 650 may provide coverage to regions on the earth 600 from 40 degrees latitude north to 40 degrees latitude south.

In an embodiment, each satellite 200 may include twelve customer dishes and two gateway dishes, each such dish being capable of pointing a steerable spot beam toward a communication destination on the surface of the earth 600 or on another satellite 600. It is noted that in other embodiments, satellites 200 may have fewer or more than two gateway dishes, and fewer or more than twelve customer dishes.

In this manner, each satellite 200 is preferably able to continuously communicate with at least one user station on the earth 600 and one gateway station 700 on the earth 600, as the satellite 200 travels along a given segment of its orbit 650 about the earth 600. In this manner, the satellite 200 serves as a link between a ground station 100 (FIGS. 1-3), which may not have a wired connection to global communication network 400 (FIG. 1) and a gateway station 700 which does have a wired connection to network 400. In some embodiments, the communication chain between a ground station 100 and global network 400 may include a succession of two or more satellites 200, instead of merely one satellite 200. In this case, one or more satellite-to-satellite communication links may be employed.

Steering of the dishes one or more of the satellites, the ground stations, and the gateway stations may be implemented by mechanical means, electronically (using phased array antennas or other mechanisms), and/or using a combination of the foregoing. In embodiments using a substantially equatorial orbit for satellites 200, the steering mechanism may be simplified and made more economical by imposing a need for only one axis of adjustment. More specifically, when a satellite 200 travels along an equatorial orbit 650, it may be sufficient to adjust the pitch angle of a steerable beam on the satellite 200 for the satellite 200 maintain a line-of-sight communication link with a selected ground station 100 on the earth 600. Where a satellite 200 travels along an inclined orbit, adjustment of the orientation of a beam on satellite may involve adjusting two orientation axes of the steerable beam to maintain line-of-sight communication with a given ground station 100.

In an embodiment, mechanically steerable dishes may be employed to continuously orient communication beams between satellite 200 and a corresponding ground station 100. In one embodiment, one-dimensional mechanically steerable beams may be employed to control dish orientations on a satellite 200 so as to maintain communication with a ground station 100. In this manner, communication between a given ground station 100 and a given satellite 200 may be maintained with a minimum of machine complexity, and at a minimum cost. Moreover, mechanically steerable spot beams are preferably able to orient beams with a high level of precision and thus effectively concentrate radio frequency (RF) energy within a small, precisely located footprint on the surface of the earth 600.

Similarly ground stations 100 and/or gateway stations 700 may also employ mechanical steering and/or electronic (such as phased array) steering to continuously track satellites and to thus maintain communication connectivity therewith. For ground stations 100 located on the equator, the option of deploying only one dimension of adjustment may exist. However, for ground stations 100 and/or gateway stations 700 at locations other than on the equator, more than one dimension of adjustment may be implemented to ensure sufficient adjustment capability is present to track satellites 200.

Moreover, in a system 10 where satellites 200 are expected to travel in a substantially equatorial orbit 650, communication dish orientation control at ground stations 100 and/or at stand-alone subscribers 500 may also employ mechanically steerable dishes for many of the same reasons discussed above for the dishes on satellites 200. Specifically, RF communication energy may be concentrated within a small and precisely located footprint so as to achieve a high level of communication bandwidth per unit of energy consumed.

However, in alternative embodiments, electronic steering, using phased array antennas, or other means may be employed in place of the mechanical steering mechanisms discussed above. Such electronic steering may be used on satellites 200, ground stations 100, and/or stand-alone subscribers 500.

Satellite system 150 (which includes one constellation of sixteen satellites in the embodiment of FIG. 6) may be supplemented with additional satellites 200 and/or additional constellations of satellites in a modular manner. Adjustment of the number of satellites 200 in satellite system 150, the locations of added satellites within satellite system 150, the communication facilities aboard each satellite 200, and of the scheduling of communication between given satellites 200 and given ground stations 100 may enable self-healing of failed communication links, avoidance of interference with GEO satellites, adjustment of concentrations of communication bandwidth, and/or power conservation. The above are discussed in greater detail below.

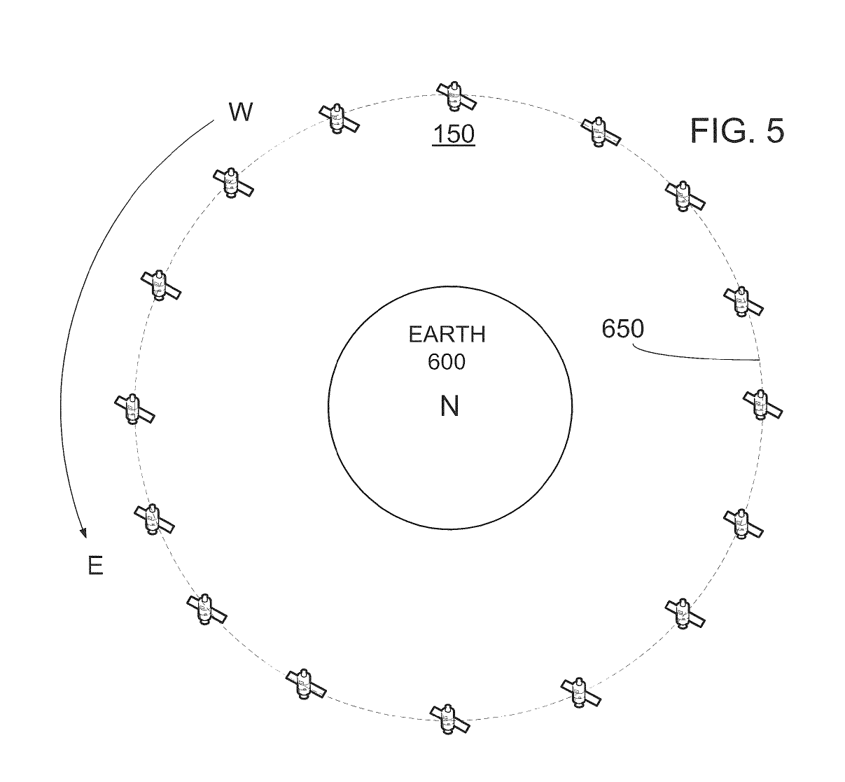

FIG. 5 is a plan view of a constellation 150 of satellites 200 in orbit around the earth 600 in accordance with one or more embodiments of the present invention. FIG. 5 presents a plan view from above the North Pole 610 of the earth 600. A constellation 150 of sixteen satellites 200 is shown in an equatorial orbit 650 around the earth, traveling from west to east as expected with an LEO or MEO orbit. As stated earlier herein, satellite system 150, which in this embodiment includes one constellation, may include fewer or more than sixteen satellites 200.

FIG. 6 is a plan view of a constellation 150 of satellites 200 in orbit around the earth 600, showing self-healing capabilities of one or more embodiments of the present invention. In FIG. 6, S1, S2, S3, S4 correspond to separate customer ground stations 100. Unless otherwise stated, each satellite 200 is assumed to be in communication with at least one gateway station (not shown), in addition to one of ground stations S1, S2, S3, or S4.

In this embodiment, satellite 200-4, at the stage of its orbit shown in FIG. 6, would normally communicate with ground station S1 and a suitable gateway station 700 (not shown). Likewise, when functioning normally, satellite 200-3 would communication with ground station S2 and a suitable gateway station. However, in the situation shown in FIG. 6, satellite 200-3 has failed. Accordingly, satellite 200-4, due to its proximity to S2, is able to conduct communication with ground stations S1 and S2, using separate respective customer dishes on satellite 200-3, thereby providing a beneficial level of redundancy, under the stated condition of a failure of satellite 200-3. In this situation, satellite 200-4, in addition to communicating with ground stations S1 and S2, preferably also communicates with at least one gateway station 700 to enable communication between ground stations S1 and S2 and global network 400.

Another self-healing scenario is shown for satellites 200-1 and 200-2. Normally, S3 could communicate with S4 through satellite 200-2 (or another satellite 200 positioned where 200-2 is shown in FIG. 6). However, where one customer dish on satellite 200-2 has failed, FIG. 6 displays an alternative path between S3 and S4 that extends from ground station S3, to satellite 200-2, to satellite 200-1, and then to ground station S4. Thus, the angular range of each satellite 200 enabled by the steerable spot beams preferably provides redundancy within satellite system 150 that enables communication system 10 to continue functioning seamlessly even in the event of a failure of a satellite 200 or a component thereof. While FIG. 6 shows an embodiment of satellite system 150 that includes sixteen satellites, the self-healing facilities discussed in connection with FIG. 6 may be practiced with fewer than sixteen satellites. Generally, the number of satellites 200 needed to provide complete coverage decreases with increasing orbit 650 altitude. At sufficiently high-altitude MEO orbits, full coverage of the earth 600 could be provided with as few as four satellites 200.

One benefit of the system disclosed herein is that even if satellite system 150 is initially deployed with six satellites which may be substantially equally distributed over a substantially equatorial orbit (as shown in FIG. 4), additional satellites 200 may be readily added to satellite system 150 without disturbing the operation of the initially deployed satellites. Instead, the initially deployed satellites and the newly added satellites may be merely controlled so as to narrow the angular range of orbit 650 (which corresponds to the geocentric angle) over which each satellite communicates with a given ground station. Thus, additional satellites may be added as needed to accommodate growing bandwidth demands, thus spreading out the deployment costs.

One ongoing concern for satellite systems in general is avoidance of RF interference with other satellite systems. Since various embodiments disclosed herein concern satellites 200 traveling in equatorial orbits, there is a need to address avoidance of interference with GEO satellites. This is because GEO satellites, though in geostationary orbit, and thus stationary with respect to the ground stations the GEO satellites communicate with, lie within an equatorial plane. Thus, at various points of the travel of a satellite 200 along a LEO or MEO equatorial orbit, there is a risk of interference between the communication between satellite 200 and its associated ground station and communication between a GEO satellite and a ground station associated with the GEO satellite. In various embodiments of the present invention, selection of bounds of latitude and/or longitude of the ground stations 100 and gateway stations 700 that a given satellite 200 communicates with at any given point along the orbit 650 of the satellite 700 are operable to avoid undesired interference with the GEO satellite RF reception and transmissions energy. Various standards have been employed in the telecommunications industry to prevent unacceptable levels of interference. In one embodiment herein, an angular separation between separate communication beams of two degrees or more is considered sufficient to avoid unacceptable levels of interference. However, those of skill in the art will recognize that the principles discussed herein may be readily extended to accommodate minimum beam separation angles that are greater than or less than two degrees.

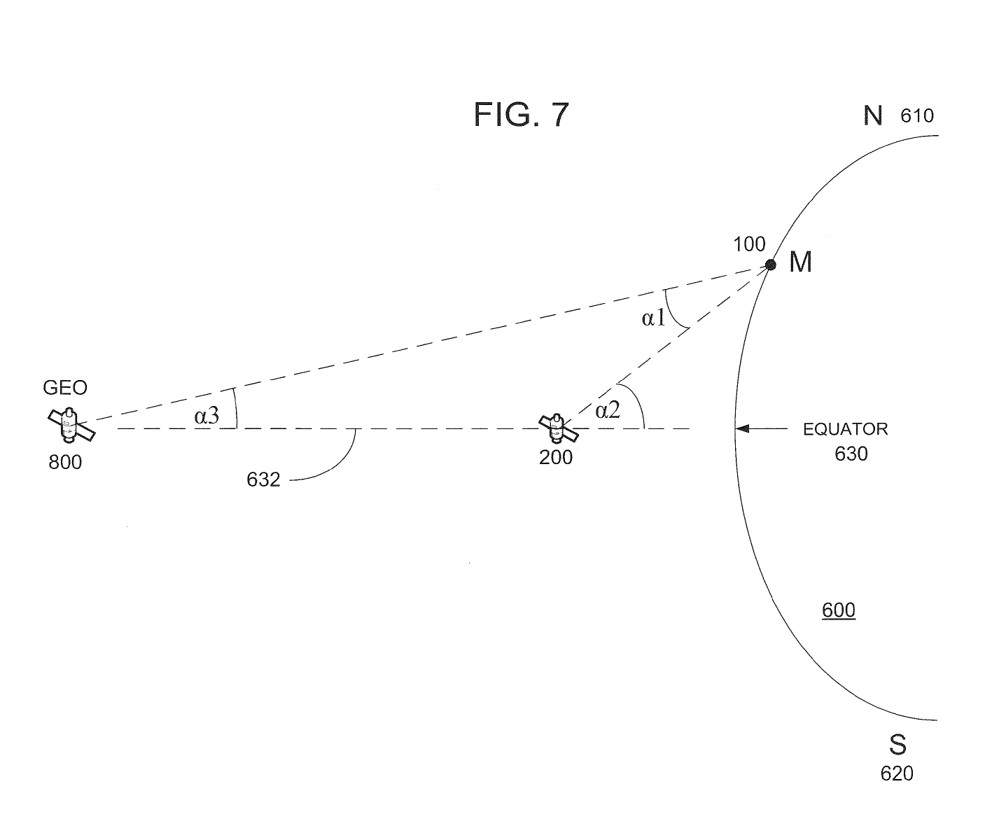

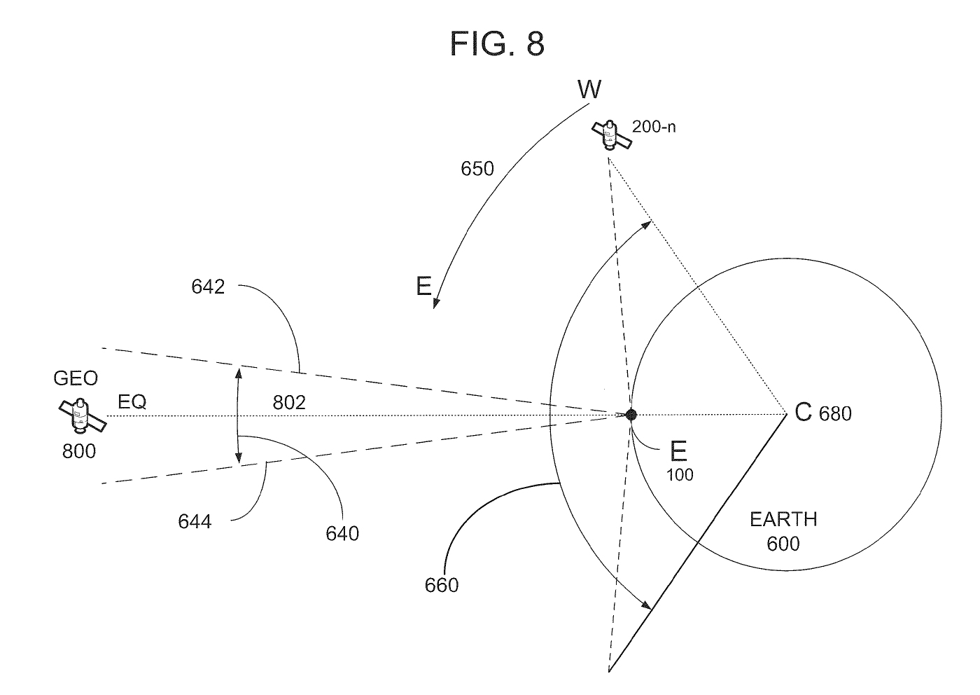

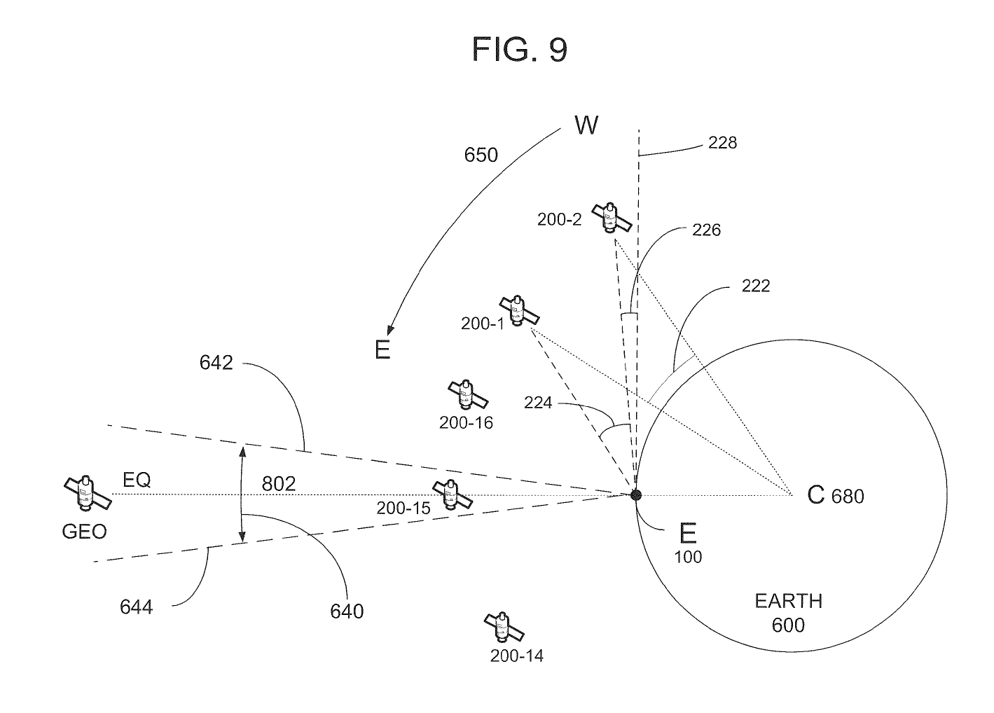

FIG. 7 is a schematic view of a north-to-south sectional plane of the earth 600 being orbited by a GEO satellite 800 and a satellite 200 forming part of satellite system 150 in accordance with an embodiment of the present invention. The earth 600 includes North Pole 610, South Pole 620, and equator 630. Dashed line 632 is a projection out from the center 680 (FIGS. 8-9) of the earth 600, through equator 630, toward GEO satellite 800. Dashed line 632 indicates that in the arrangement of entities shown in FIG. 7, GEO satellite 800 and satellite 200 are in line with the equator 630, and there is an apparent risk of interference.

However, by establishing bounds for the latitudes of ground stations that satellite 200 may communicate with, interference may be beneficially avoided. A set of exemplary values are provided to illustrate this point. Using an earth 600 radius of 6,400 km, a satellite 200 altitude of 8,000 km, ground station 100 would have to be at a latitude of 3.2 degrees or greater (either North or South) for the discrimination angle α1 to meet or exceed two degrees. Clearly, the larger the required discrimination angle is, the greater the latitude angle ground station 100 will have to be at to avoid interference between satellite 200 and satellite 800.

In the example shown in FIG. 7, GEO satellite 800 and satellite 200 may both communicate with ground location “M” (for Mexico City, which is at a latitude of about 19 degrees North) without incurring interference even though satellites 800 and 200 are in line with equator 630.

Various beam separation angles (α1, α2, and α3,) are shown in FIG. 7, each corresponding to an angular separation between two separate communication beams. As discussed earlier, unacceptable interference may be avoided so long as the separation between beams impinging on either a ground station or satellite are separated by more than a minimum discrimination angle. This minimum discrimination angle may be between two degrees and four degrees, but may also be below or above 2-4 degree range. The minimum discrimination angle may vary as a function of the size and shape of a satellite dish, the processing equipment coupled to the satellite dish, and/or the frequency and/or power of each of the signals impinging on the dish at any given moment. In the embodiment of FIG. 7, the angular separation between beams impinging on any given receiver are clearly greater than the minimum discrimination angle values discussed above. Moreover, the principle of interference avoidance may be extended to communication equipment having any minimum discrimination angle value. Thus, the exemplary arrangement of FIG. 7 is provided to illustrate one method by which embodiments of the present invention may avoid interference. However, the present invention is not limited to employing the beam separation angles shown in FIG. 7 or any other Figure in this application.

In the embodiment of FIG. 7, non-interference between the various communication beams is made possible because the separation angle α1 between (a) the communication path between point M and satellite 800 and (b) the communication path between point M and satellite 200 is sufficient to prevent these two beams from interfering with one another at ground station 100 at point M. Preferably, in this embodiment, beam separation angles α2 and α3 also exceed the minimum discrimination angles for satellite 200 and satellite 800, respectively.

Preferably, the above-discussed beam separation angles operate to prevent interference between beams directed toward a common point even if the two beams employ the same frequency. While detailed formulas are not provided herein, it may be seen that the separation angle between the GEO satellite 800 to M beam and the satellite 200 to M beam may be kept above the minimum separation angle by selecting ground stations 100 for communication with satellite 200 that are greater than a certain minimum angular distance (as measured in degrees of latitude) from the equator 630 in either a northern or southern direction.

The above addresses bounds for the latitude of ground stations 100 that a satellite 200 may communicate with when satellite 200 is in line with a GEO satellite 800 within an equatorial plane. However, where satellite 200 is not in proximity to a GEO satellite communication beam, it should be noted that the above-discussed constraints on the permissible latitudes for ground stations that can communicate with satellite 200 are not present. Thus, where no risk of interference with GEO satellite communications exists, satellites 200 may communicate with ground stations at any latitude within the latitudinal communication range of the satellite 200, which may be between 40 degrees latitude north and 40 degrees latitude south.

Having discussed restrictions on latitude, we turn next to methods for avoiding interference between satellites 200 within satellite system 150 and GEO satellites 800 when both the GEO and non-GEO satellites are communicating with ground stations located at or very near the equator.

FIG. 8 is a schematic view of an equatorial plane of the earth 600 being orbited by a GEO satellite 800 and a satellite 200-n forming part of a non-GEO satellite system 150 in accordance with an embodiment of the present invention. FIG. 8 shows point E on the equator and at the surface of the earth at which a ground station 100 is located. It will be appreciated that satellite system 150 may operate in orbits either below or above the altitude of the orbit described in connection with FIGS. 8 and 9.

In this embodiment, when satellite system 150 seeks communication with a ground station 100 at location E on the equator 630 in a region in which other stations receive and transmit RF energy along path 802 to GEO satellite 800, interference between satellites 200 of satellite system 150 and the GEO satellite 800 communication may be avoided by employing satellites 200 within satellite system 150 that are outside a specified forbidden angular range 640 within which a risk of interference exists. The deployment of steerable beams on satellites 200 preferably operates to enable satellites 200 to communicate with ground station at point E on the equator 630 of the earth 600 without incurring interference with communication between GEO satellite 800 and its associated ground station(s) at or near point E.

In the embodiment of FIG. 8, satellite 200-n of satellite system 150 is in an MEO orbit at an altitude of about 6,000 km. Satellite system 150 preferably enables satellites 200 well outside the forbidden angular range 640 but still within a communication range 660 of point E on equator 630 to conduct communication with ground station 100 at point E. In this embodiment, ground station 100 at point E may conduct communication with any satellites 200 that are at topographic angles (angles as seen from surface of the earth 600) five degrees of elevation or more above the eastern and western horizons. The above constraints still enable ground station at point E to communicate with satellites 200 over the most of communication range 660. In this embodiment, at the stated altitude, and with the stated constraints on elevation above the horizon, communication range 660 is about 110 degrees for ground station 100 at point E.

More specifically, non-interfering communication between ground station 100 at point E may occur over all of communication range 660 other than the segment of orbit 650 within forbidden range 640. A more specific example of the orbit/constellation configuration discussed above is considered in connection with FIG. 9.

FIG. 9 is a schematic view of an equatorial plane of the earth 600 being orbited by a GEO satellite 800 and two satellites 200-1, 200-2 forming part of a non-GEO satellite system 150 in accordance with an embodiment of the present invention. As in FIG. 8, point E corresponds to the location of a ground station 100 located on the equator 630. The scheme for interference avoidance presented herein preferably operates the same way regardless of the longitude of point E. Accordingly, the longitude of point E 100 is not specified.

FIG. 9 shows successive satellites 200-1 and 200-2 within satellite system 150 in an equatorial orbit at an altitude of about 6,000 km above the surface of earth 600. The angular separation between satellites 200-1 and 200-2 is indicated by geocentric angle 222 (the separation angle as measured from the center 680 of the earth 600) and/or topocentric angle 224 (the separation angle as seen from point E on the surface of the earth 600). In the embodiment of FIG. 9, satellite system 150 preferably includes sixteen satellites that are equally spaced along orbit 650 (FIGS. 4-5). With sixteen equally spaced satellites, the angular distance between successive satellites 200-1 and 200-2 is equal to 22.5 degrees. Thus, continuous communication connectivity between satellite system 150 and ground station 100 at point E may be achieved by having each satellite 200 maintain communication over a 22.5 degree range of travel along orbit 650. However, in alternative embodiments, the connectivity between any given satellite 200 and ground station 100 could be varied as desired, within the limits of the communication access of the various satellites 200. As stated earlier, when using an altitude of 6,000 km, and a constellation of sixteen satellites 200 equally spread out over orbit 650, up to five satellites may have line-of-sight communication ability with ground station 100 at point E at any given moment. Thus, it may be seen that many possible variations of the above connectivity scheme may be practiced.

In the embodiment of FIG. 9, communication range 660 is about 110 degrees (using an altitude of 6,000 km and the constraint that satellite 100 be 5 degrees or more above the eastern and western horizons for communication to occur). Interference avoidance with GEO satellite 800 may be achieved by establishing a forbidden range of about 2 degrees of topocentric angular range as seen by ground station 100 at point E, having a centerline 802, and borders 642 and 644, pointing from the center 680 of the earth 600 to GEO satellite 800. Thus, forbidden range 640 preferably includes about 1 degree of angular range on either side on the centerline 802. However, the angular magnitude of forbidden range 640 may be increased or decreased depending on the sensitivity of one or more of the communicating devices to interference. The present invention is not limited to the use of a forbidden range of any particular magnitude. In other embodiments, where equipment characteristics permit, forbidden ranges greater than or smaller than the range of 2 degrees may be employed.

In the following, one particular approach for interference avoidance is described. It will be appreciated that the invention is not limited to this approach, as many communication arrangements are possible that provide continuous connectivity for satellite system 150 with ground station 100 while avoiding interference with GEO satellite 800.

By way of overview, various aspects of the satellite orbit, the satellite constellation design, and the nature of RF communication generate various resulting circumstances within which various communication options or schemes become available. More specifically, design aspects such as the orbit 650 altitude above the earth 600, the number and spacing of satellites 200 within satellite system 150 (in this case a single constellation 150) determine the following resulting circumstances:

the minimum topocentric elevation angle for satellite 200 above the horizon (which has a topocentric angle of zero degrees) to enable communication with ground station 100;

(b) the communication range 660 which corresponds to a portion of orbit 650 within which a given ground station has line-of-sight communication access with satellites 200 of satellite system 150;

(c) the range of longitude w within which a ground station can be located and still communicate with a given satellite 200 at a given point along its orbit 650; and

(d) the total number of satellites of satellite system 150 having line-of-sight communication ability with a given ground station 100 at any given moment.

Separately, the sensitivity to interference of GEO satellite 800 and its associated ground station may determine the angular value of the forbidden range 640.

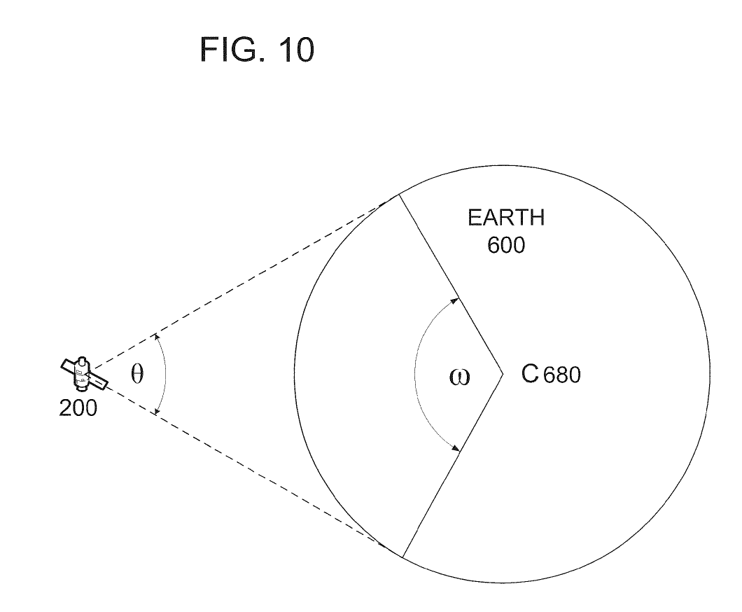

Some specific values are now described for an exemplary embodiment. In this example, we employ an orbit 650 altitude of about 6,400 km (about equal to the radius of the earth) and sixteen satellites equally spaced within orbit 650, a negligible elevation angle, a communication range 660 of about 110 degrees, a communication longitude range ω for a given satellite 200, (at a given moment) of about 120 degrees (FIG. 10), and total of 5 satellites 200 that may be visible to (i.e. have the potential to communicate with) a given ground station at a given moment. The range of longitude visible to a given satellite 200 at a given moment is shown by the angle ω in FIG. 10. This range of longitude generally increases with increasing altitude of orbit 650. The angle θ in FIG. 10 corresponds to the angular range through which a beam on satellite 200 may be steered to be able to communicate with ground stations on the surface of the Earth 600, within longitude range ω.

The above conditions, including the recited negligible elevation angle, yielded a communication longitude range ω of about 120 degrees. The requirement for a minimum topocentric elevation angle at ground stations 100 will reduce the communication longitude range ω. Moreover, for a given satellite at a given altitude, the communication longitude range ω will decrease with increasing minimum topocentric elevation angle. For example, at an altitude of 6,000 km, with a minimum elevation angle of 5 degrees, it has been determined that each satellite 200 will have a communication longitude range ω of about 108 degrees. At this same altitude (6,000 km), in a system using sixteen equally angularly spaced satellites, and thus located at 22.5 geocentric degree intervals about orbit 650, a satellite at ground station 100 at point E (FIG. 9) would rotate through an angular range of about 45.5 degrees.

A forbidden range 640 value of 2 degrees is considered to apply in this example. However, this value may vary depending on the circumstances. It will be understood to those of ordinary skill in the art that changing the design aspects of the orbit 650 and the constellation 150 will cause the above-listed resulting circumstances to change as well. Moreover, it will be understood that the present invention is not limited to the above-stated design aspects or the above-listed resulting circumstances.

The flexibility and redundancy enabled by the embodiment of FIG. 9 enables various options for enabling communication of ground station 100 at point E with a succession of satellites 200 of satellite system 150 without impinging on the communication reception or transmission of GEO satellite 800. One such option is discussed below. However, others may be practiced.

An example is considered in which ground station 100 at point E communicates with satellites 200-1 and 200-2 over a 22.5 degree geocentric angular segment of orbit 650, at an altitude of 6,000 km. FIG. 9 shows a point in the sequence of steps at which a handoff may occur between satellite 200-1 and satellite 200-2. Preferably, ground station 100 communicates with each satellite 200 starting at the location satellite 200-2 is shown at in FIG. 9 and ends the communication session when each satellite 200 reaches the position that satellite 200-1 is shown at in FIG. 9. The geometry of the situation is best described using a combination of topocentric and geocentric angles.

In this example, communication between each satellite 200 and ground station 100 may begin when satellite 200 is 5 (topocentric) degrees above the horizon. This situation is shown in FIG. 9, with line 228 being drawn from ground station 100 at point E toward the horizon in the West. The minimum elevation angle, which in this case equals 5 degrees from the horizon is shown by angle 226. Satellite 200-2 is shown at this minimum elevation angle in FIG. 9. Thus, once a satellite 200 reaches minimum elevation angle 226, connectivity between satellite 200 and ground station 100 may begin. This connectivity may continue as satellite 200 progresses along orbit 650 (which progresses counter-clockwise in the view of FIG. 9). In this embodiment, satellite 200 preferably advances 22.5 degrees (geocentric degrees) along orbit 650 during the connectivity session with ground station 100, as shown by geocentric angle 222. This 22.5 degree angular distance corresponds to one sixteenth of one complete orbit around the earth 600 and is thus consistent with the above description of the constellation of satellite system 150 including sixteen equally angularly spaced satellites 200.

When the satellite 200 completes its progress through the 22.5 degree orbit segment, discussed above, it reaches the point that satellite 200-1 is shown at in FIG. 9. At this stage, connectivity of ground station 100 to satellite system 150 may be handed off to the next (next satellite in the constellation in the clockwise direction) satellite 200. With reference to the specifically numbered satellites in FIG. 9, once satellite 200-1 completes the 22.5 degree orbit segment indicated by angle 222, connectivity of ground station 100 is preferably transferred from satellite 200-1 to satellite 200-2. Thereafter, the above-described sequence may be repeated for satellite 200-2, and after that with satellites 200-3 (not shown), 200-4 (not shown), etc. . . . When employing a satellite system 150 having a constellation with sixteen satellites equally angularly spaced along orbit 650, at the stated altitude of 6,000 km, continuous connectivity of ground station 100 to satellite system 150 (and thus to global network 400) may be achieved by repeating the above steps of conducting communication with a satellite 200 through orbit segment 222, and then handing off connectivity to the next satellite in the constellation. It will be appreciated that satellite system 150 may include fewer or more than sixteen satellites. Changing the number of satellites in satellite system 150, the altitude of orbit 650, and/or other parameters of communication system 10 may require that orbit segments with angular ranges other than those discussed above be employed. In various embodiments of the present invention, the flexibility of the communication arrangements, and the desirable redundancy of satellite system 150 will increase as the number of satellites within satellite system 150 increases.

As satellite 200 moves along orbit segment 222, the change in topographic angle of satellite 200 as seen by ground station 100 at point E, indicated by angle 224, may be substantially more than the 22.5 degree value of angle 222. However, angle 224 is relevant mostly to the adjustment of the orientation of communication dishes and/or other tracking equipment at ground station 100 and/or on satellite 200. It may be seen that the topographic angle 224 that tracking equipment will rotate through as satellite 200 moves through a given angular orbit segment 222 increases with decreasing altitude of orbit 650. By way of illustration, for a very low altitude orbit 650, angle 224 would have to rapidly rotate from the western horizon to the eastern horizon to follow satellite 200 along a relatively small orbit angular segment 222.

From the above, it is clear that when communication range 660 is much larger than the orbit segment 222 needed for each satellite, a connectivity “session” of ground station 100 with each satellite may be conducted at a safe angular distance from forbidden range 640. As discussed earlier herein, this beneficially avoids interference with the reception/transmission RF energy for GEO satellite 800. While one such interference avoidance scheme is presented above, the geometry of orbit 650 and of satellite constellation 150 make many other such schemes possible. For instance, it may be readily seen from FIG. 9 that considerable angular space remains within communication range 660 (FIG. 8) of ground station 100 beyond orbit segment 222 that was employed in the above described embodiment.

Having provided an overview of the geometry of the orbit 650 and of the arrangement of ground stations 100 and gateway stations 700, we now provide some more detailed examples of the operation of an embodiment of the present invention over a portion of the earth 600.

The following examples discuss embodiments including an equatorial orbit 650 for the sake of illustration. However, the present invention is not limited to having satellites follow a purely equatorial orbit. Satellites within satellite system 150 may follow inclined orbits, if desired. Such inclined orbits may depart from the equator to any desired extent, such as, for instance, 1 degree of latitude or less, 5 degrees of latitude or less, or 10 degrees of latitude or less. In other embodiments, orbit 650 may depart from the equator by 10 degrees of latitude or more.

Various figures herein illustrate some earth stations as being ground stations 100 and others as gateway stations 700. In some embodiments, ground stations 100 are earth stations that do not have wired connections to global network 400, and gateway stations 700 are earth stations that do have such wired connections to global network 400. However, the present invention is not limited to the above-described arrangement. Some earth stations may function as both ground stations 100 and as gateway stations 700. Some ground stations 100 may have wired connections to a global network but still communicate through satellite system 150 for certain purposes. Moreover, some gateway stations 700 having connections to global network 400 may still communicate with one or more other gateway stations 700 in the event that satellite system 150 offers more convenient and/or more rapid communication over a particular segment of the earth 600. Otherwise stated, one or more ground stations 100 and one or more gateway stations 700 may have functions that are interchangeable. In any case, the communication connections available to a given earth station may change over time.

Thus, a ground station 100 that is located in tropical area that currently does not have a wired connection to global network 400 and thus depends exclusively on satellite communication for global connectivity, could eventually acquire such a wired connection to global network 400. Even upon the deployment of such a wired connection, satellite system 150 of the present invention could still provide valuable additional bandwidth for the now-wired ground station 100.

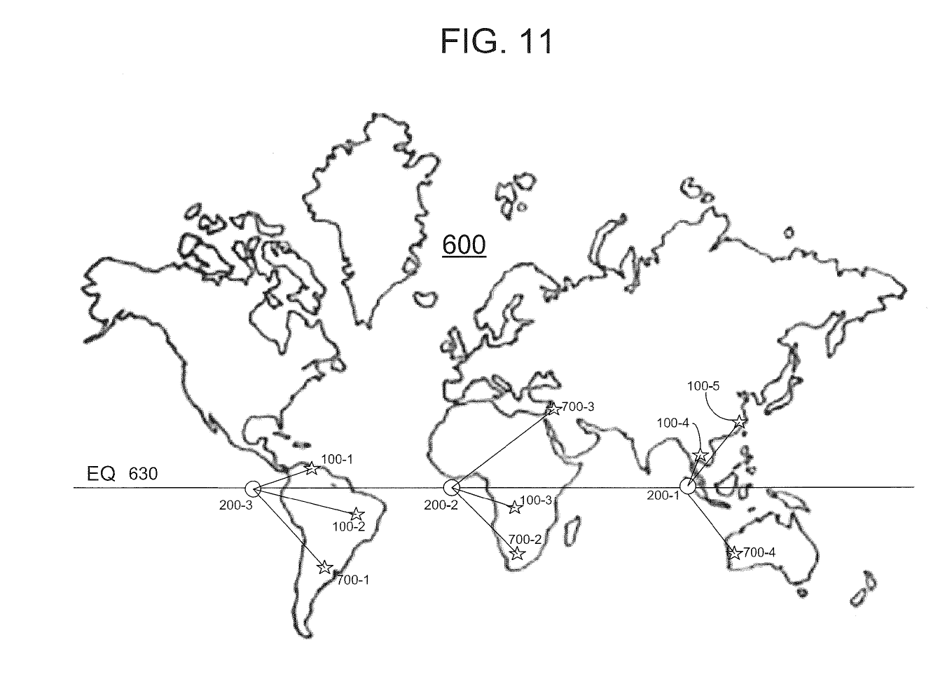

FIG. 11 is a view of a Mercator projection map of a portion of the earth 600 showing a selection of satellites 200 orbiting the earth 600 in accordance with one or more embodiments of the present invention.

FIG. 11 shows satellites 200-1, 200-2, and 200-3 in proximity to South America, Africa, and Asia, respectively. Various earth stations are shown, including ground stations 100-1 near Caracas, Venezuela; 100-2 near Brasilia, Brazil; 100-3 near Kinshasa, Zaire; 100-4 near Kuala Lumpur, Malaysia; and 100-5 near Bangkok, Thailand. FIG. 11 further shows gateway stations 700-1 near Buenos Aires, Argentina; 700-2 near Johannesburg, South Africa; 700-3 near Tel Aviv, Israel, and 700-4 near Perth, Australia. In this embodiment, satellites 200-1, 200-2, and 200-3 are shown traveling along the equator 630. For the purpose of this discussion, it is presumed that ground stations 100-1, 100-2, 100-3, 100-4, and 100-5 lack wired connections to global network 400.

FIG. 11 provides a simplified view of various satellites 200, ground stations 100, and gateway stations 700 to illustrate how satellite system 150 can provide backhaul services to ground stations 100 that lack wired connections to a global network 400. The identification of ground stations, gateway stations, and cities is provided for the sake of illustration, and does not necessarily reflect the connectivity currently available at any particular location.

For the sake of discussion in FIG. 11, ground stations 100-1, 100-2, and 100-3, 100-4, and 100-5 located near Caracas, Brasilia, Kinshasa, Kuala Lumpur, and Bangkok respectively, are treated as lacking wired connections to the rest of the world, and therefore needing satellite system 150 to provide connectivity to global network 400 for the various above-listed ground station locations. Although constellations of satellites 200 constantly move along their orbits, the situation shown in FIG. 11 is discussed, as though static, for the sake of convenience.

In this embodiment, satellite 200-3 preferably communicates with ground stations 100-1 and 100-2, and gateway station 700-1. Under circumstances where gateway station 700-1 (near Buenos Aires) has a wired connection to global network 400, satellite 200-3 is preferably able to extend this global connectivity to ground stations 100-1 (near Caracas) and 100-2 (near Brasilia), which for the sake of this example are treated as not having wired connections to global network 400. Thus, in this case, satellite system 150 may provide the only low-latency communication solution for ground stations 100-1 and 100-2.

In this embodiment, a similar situation may exist for satellite 200-2 which is shown located proximate to the African continent. In this embodiment, ground station 100-3 located near Kinshasa, Zaire is treated as lacking a wired connection to global network 400. Meanwhile, gateway stations 700-2 near Johannesburg and 700-3 near Tel Aviv are treated as having wired connections to global network 400. Thus, at a minimum, in this embodiment, satellite system 150, represented at the point in time shown in FIG. 10 by satellite 200-2 may be operable to provide low-latency (high-speed) backhaul communication service to ground station 100-3 by linking ground station 100-3 to gateway station 700-3 and/or gateway station 700-2.

However, the invention is not limited to providing only the above-listed function. Where desirable, satellite 200-2 also provides a useful communication link directly between gateway stations 700-2 and 700-3. In some cases, the wired connections to global network 400 available to gateway stations 700-2 and 700-3 may make the use of satellite system 150 unnecessary for direct communication between stations 700-2 and 700-3. However, in other instances, satellite system 150 may still serve as a useful additional link offering low-latency, high-bandwidth communication services between gateway stations 700-2 and 700-3. Moreover, in special circumstances, such as when a wired link fails, satellite system 150 could serve as a valuable backup communications option between gateway stations 700-2 and 700-3.

Similar to the above, satellite 200-1 may have communication links to gateway station 700-4, ground station 100-4, and/or ground station 100-5. For the sake of this discussion, ground stations 100-4 and 100-5 are treated as not having wired links to global network 400. Thus, in this situation, satellite 200-1 may be operable to provide backhaul communication service to gateway station 700-4 from ground station 100-4 (near Kuala Lumpur) and/or ground station 100-5 (near Bangkok).

A selection of particular cities at certain selected latitudes and longitudes was used to illustrate certain aspects of one or more embodiments of the present invention. However, it will be apparent to those having ordinary skill in the art that the principles discussed herein may be readily extended to any earth station in or near any city, at any longitude on the earth 600. Moreover, an embodiment of the present invention is capable of delivering the above described services within a north-to-south range from 40 degrees latitude north to 40 degrees latitude south.

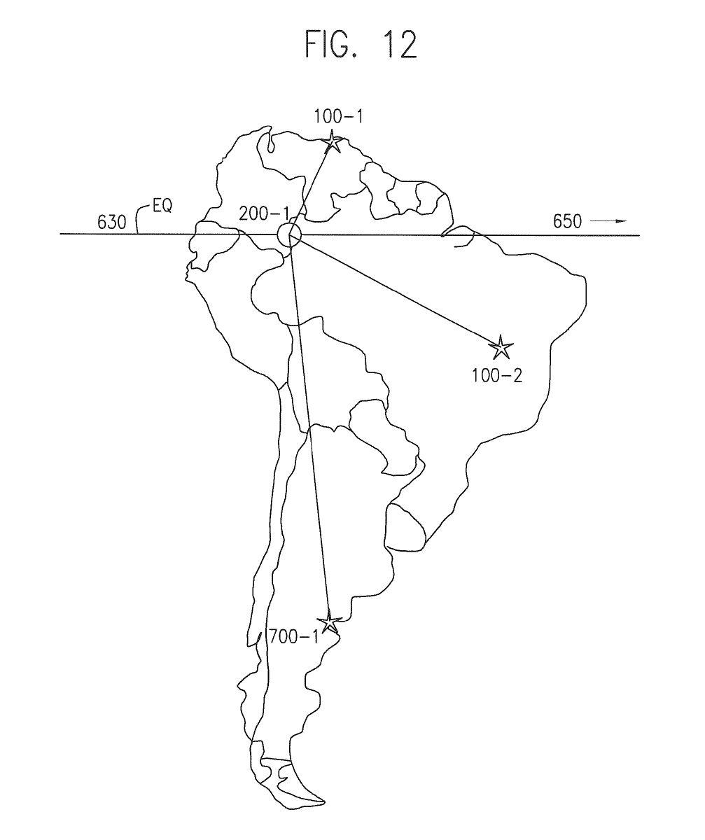

In FIGS. 12-14, a sequence of communication sessions conducted by a succession of two satellites orbiting over South America is discussed. The discussion uses a sequence of static figures to help illustrate the dynamic operation of an embodiment of the present invention. While only two satellites 200-1 and 200-2, and three earth stations at three respective cities are shown, it will be appreciated that any number of locations within the latitude range of satellite system 150 may be serviced by one or more embodiments of the present invention.

FIG. 12 is a schematic plan view of a satellite 200-1 forming part of a constellation (satellite system 150) traveling along an equatorial orbit 650 over South America in accordance with an embodiment of the present invention. FIG. 12 shows the South American continent, equator 630, satellite 200-1 traveling along the equator. Recalling the arrangement discussed above in connection with FIG. 11, satellite 200-1 is preferably in communication with ground station 100-1 (near Caracas), ground station 100-2 (near Brasilia), and gateway station 700-1 (near Buenos Aires). In one embodiment, satellite 200-1 may provide backhaul communication for ground stations 100-1 and 100-2 (which may lack wired connections to global network 400) to gateway station 700-1, which preferably has a wired connection to global network 400.

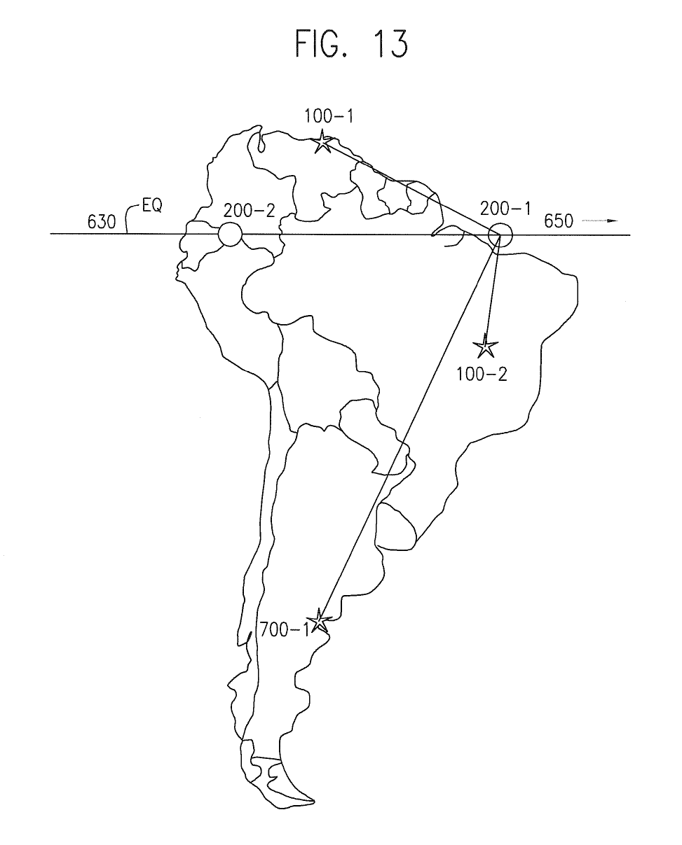

FIG. 13 shows the system of FIG. 12 in which satellite 200-1 has advanced eastward along its orbit 650 but which remains in communication with ground stations 100-1 and 100-2, and with gateway station 700-1. Moreover, satellite 200-2, of satellite system 150, has entered the view of FIG. 13.

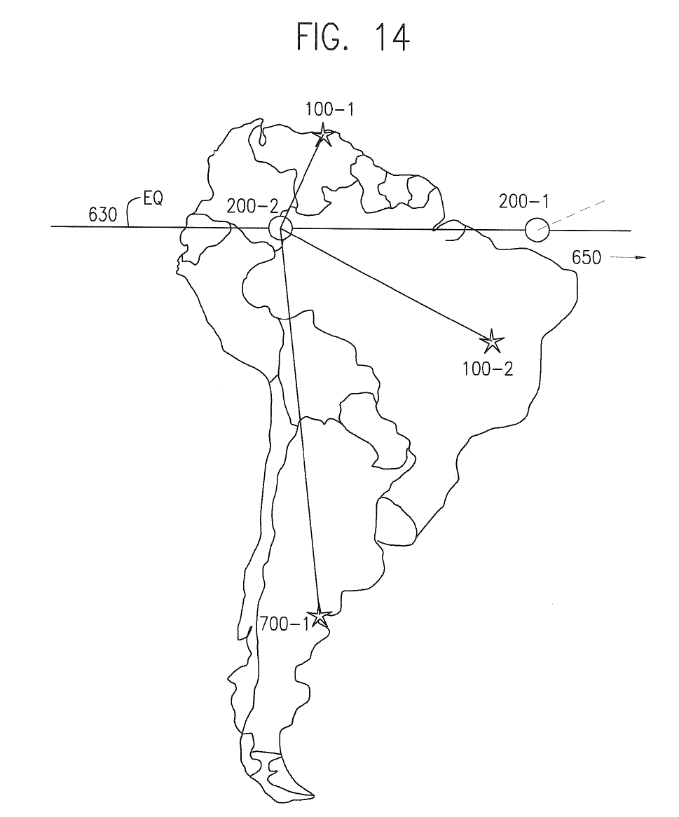

A still further stage of advancement is shown in FIG. 14, in which communication from ground stations 100-1 and 100-2, and gateway station 700-1 has been handed off from satellite 200-1 to satellite 200-2. The dashed line extending north-east from satellite 200-1 is intended to illustrate the initial stage of establishing a communication path between satellite 200-1 and an earth station further along orbit 650, such as on the west coast of Africa. The precise location of such an earth station is not central to this discussion, and thus none is specified.

Preferably, as the constellation of satellites 200 continues to travel along orbit 650, an infinite succession of satellites 200 forming part of satellite system 150 continues to enter the communication range, shown in FIGS. 12-14 for earth stations 100-1, 100-2, and 700-1 from the West, as satellite 200-2 is shown doing in FIG. 14, to then advance along the orbit 650 within South America, and to then leave the communication region for earth stations 100-1, 100-2, and 700-1 as each satellite heads eastward away from South America, as satellite 200-1 is shown doing in FIG. 14. In this manner, satellite system 150 is preferably able to maintain continuous connectivity with ground stations 100-1 and 100-2, and gateway station 700-1, even as individual satellites 200 enter and then leave the communication range of these earth stations.

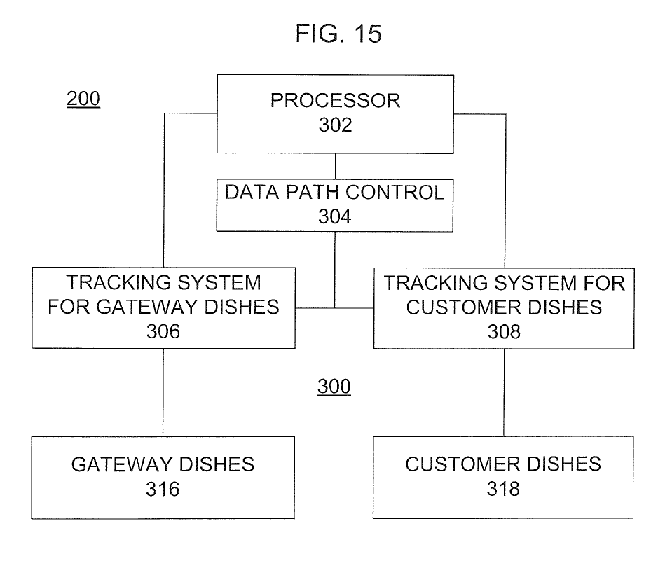

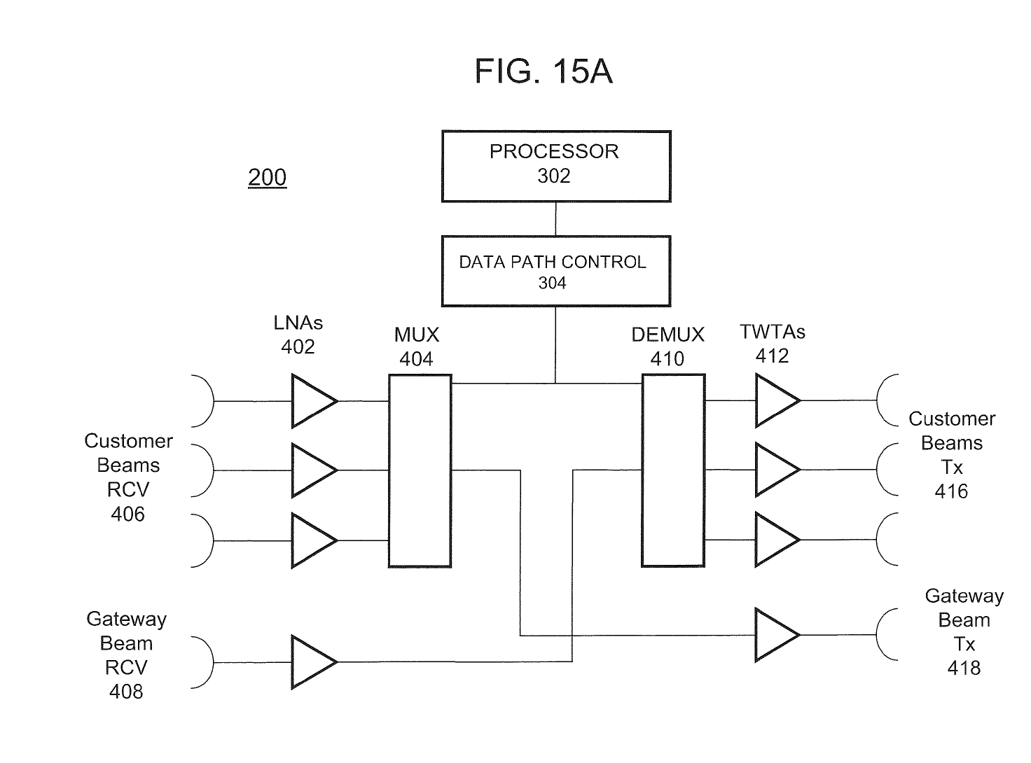

FIG. 15 is a functional block diagram of the hardware 300 aboard a satellite 200 in accordance with one or more embodiments of the present invention. Satellite hardware 300 may include processor 302, data path control 304, gateway dish tracking system 306, customer dish tracking system 308, gateway dishes 316, and/or customer dishes 318.

Processor 302 may be a general purpose processor having access to volatile and/or non-volatile memory. Processor 302 may be operable to coordinate the flow of data among the gateway dishes 316 and customer dishes 318. Data path control 304 is preferably operable to control the flow of data from various transponder inputs, along waveguides, and to various transponder outputs within satellite 200. Data path control 304 may be implemented using one or more MUX frequency splitters, by processor 302, by other devices, or using a combination of one or more of the foregoing.

Gateway dish tracking system 306 is preferably operable to enable gateway dishes 316 to maintain a communication path with a counterpart dish it is communicating with, where the counterpart dish may be on the surface of the earth 600 or on another satellite. The operation of tracking system 306 depends on the type of dish and beam used with dishes 316. The above discussion also applies to customer dish tracking system 308 and customer dishes 318, respectively. Below, two types of antenna are discussed along with tracking systems corresponding to each antenna type.

In one embodiment gateway dishes 316 and/or customer dishes may include a feed and one or more reflectors suitable for directing a spot beam in a desired direction. In this embodiment, the beam direction established may be mechanically steering the antenna assembly so as to control the orientation of the dish along one or more angular dimensions. The tracking system suitable for interacting with a mechanically steerable antenna is discussed next.

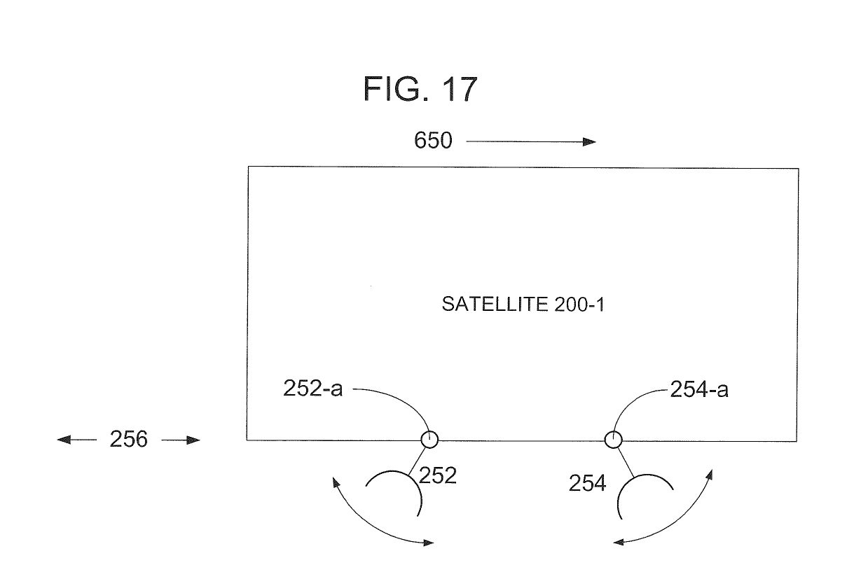

When gateway dishes 316 or customer dishes 318 employ mechanically steered antennas (such as those discussed in connection with FIG. 17) that continuously adjust the orientation of spot beams for transmission from and reception by dishes 316 or 318, tracking system 306 or 308 preferably operates to control the orientation of a dish along the pitch dimension, or both pitch and roll angular dimensions so as to keep dish 316 or 318 in continuous communication with whatever communication target the dish (either 316 or 318) is communicating with (where the communication target may be a ground station or another satellite). Suitable beam strength sensing equipment and motor controls may be implemented to suitably adjust the orientation of dishes 316 and 318 to maintain the communication path at or above an acceptable power level.

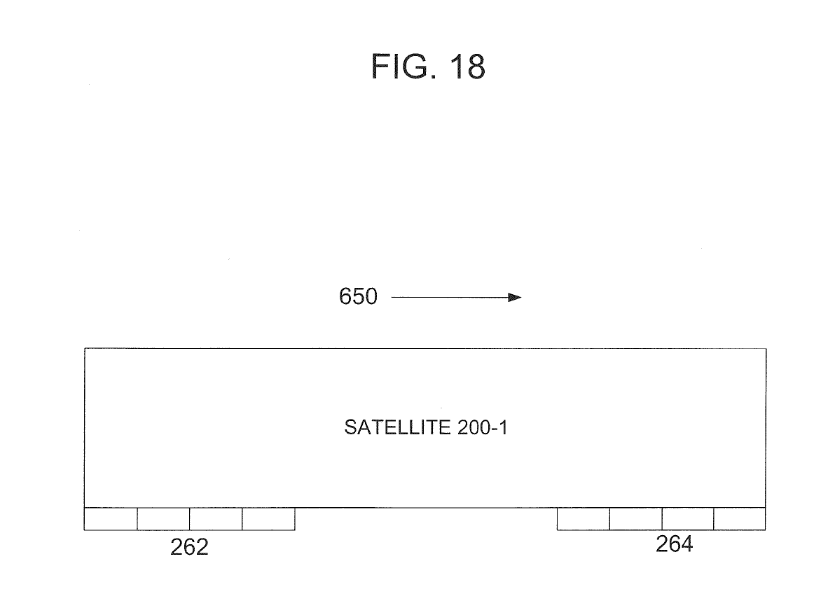

When gateway or customer dishes 316, 318 employ phased array antennas (such as those discussed in connection with FIG. 18), tracking systems 316 and/or 318 may include beam sensing equipment and beam control equipment suitable for configuring communication beams for dishes 316 and/or 318. This step of configuring preferably includes controlling the direction and communication power of communication paths for dishes 316 and/or dishes 318. In one or more embodiments, controlling the direction and communication power of phased array antennas may include adjusting the energy levels of an array of antenna elements within each of the antennas so that the combination of the contributions of the respective antennas array elements for a given antenna results in a single beam of desired direction and desired communication power.

Customer dishes 318 and gateway dishes 316 may include any one of several types of satellite communication dishes capable of bi-directional communication with one or more ground stations, one or more other satellites, and/or a combination of ground stations and other satellites. Satellite 200 may include any number of customer dishes 318 and any number of gateway dishes 316.

FIG. 15A is a schematic representation of equipment aboard a satellite 200 in accordance with one or more embodiments of the present invention. The processor 302 and data path control 304 of FIG. 15A preferably correspond to the like numbered entities described above in connection with FIG. 15. Accordingly, the descriptions of those items is not repeated in this section. Satellite 200 equipment may include processor 302, data path control equipment 304, low noise amplifiers 402, multiplexer (mux) 404, demultiplexer (demux) 410, traveling wave tube amplifiers (TWTAs) 412. Satellite 200 may receive customer beams 406 and gateway beam 408, and may transmit customer beams 416 and gateway beam 418.

Satellite 200 may receive customer beams 406 and gateway beam 408. The received beams may proceed through respective Low-Noise Amplifiers (LNAs) 402. The received gateway beam 408 may proceed to demux 410 and be directed out of satellite 200 along one or more of customer beams 416 and/or along gateway beam 418 under the control of data path control 304 and processor 302. In either of the above paths, the outbound beam is amplified in one or more TWTAs 412 prior to transmission out of satellite 200.

The received customer beams 406, after amplification, may proceed toward multiplexer 404, after which beams 406 may be directed toward along gateway beam 418 and/or toward demux 410 toward outbound customer beams 416 for transmission out of satellite 200. In either case, the outbound beams pass through TWTAs 412 prior to being transmitted out of satellite 200.

The number of gateway beams and customer beams in FIG. 15A is for illustration purposes. In other embodiments, fewer or more than three inbound and outbound customer beams may be employed. Moreover, in other embodiments, two or more gateway beams may be received at and/or transmitted from satellite 200.

For the purpose of illustration, customer receive beams 406 and customer transmit beams 416 are shown separately, as are the reception beams 408 and transmission beams 418 for the gateways. However, in one or more embodiments, individual antennas may be employed for both reception and transmission of data. In other embodiments, the data transmission task and the data reception task may performed by separate antennas for one or more of the customer and/or gateway communication paths.

FIG. 16 is a block diagram showing a plurality of communication dishes on satellite 200 in accordance with one or more embodiments of the present invention. In this embodiment, each dish may both transmit and receive wireless radio frequency communication.

Satellite 200 may include gateway transponders GW1 and GW2 for communication with two respective gateway stations on the earth. In other embodiments, satellite 200 could include fewer or more than two gateway transponders. Satellite 200 may further include twelve dishes (each with an associated transponder, as needed or desired) for communication with ground stations that are in communication with customers, including transponders C11, C12, C13, C14, C21, C22, C23, C24, C31, C32, C33, and C34. While twelve communication dishes directed to customer communication are shown in FIG. 7, fewer or more than twelve communication dishes could be included within satellite 200. One or more of the dishes on satellite 200 may be steerable mechanically and/or electronically so as to track a fixed location on the earth, a moving target on the earth, and/or another satellite, as satellite proceeds along orbit 650. Steering ability may be provided in one or more orientation dimensions as needed or desired for a given application. In one embodiment, one or more customer communication dishes and/or one or more gateway dishes may be economically configured to track earth stations in only one dimension. In other embodiments, one or more customer dishes and/or one or more gateway dishes may be configured to track their respective communication targets (whether stationary earth stations, moveable earth stations, and/or other satellites) in two angular dimensions.

In one embodiment, data received at an input of any of the transponders of satellite 200 shown in FIG. 7 may be routed so as to be output from any of the fourteen transponders, including the transponder that the data was received at. In other embodiments, to achieve greater economy, a more limited set of signal transmission routing options may be made available within one or more satellites 200 within a constellation of such satellites.

FIG. 17 is a schematic representation of satellite 200 having two mechanically steerable antennas 252, 254 in accordance with one or more embodiments of the present invention. Antenna 252 preferably rotates about axis 252-a, and antenna 254 preferably rotates about axis 254-a. Axes 252-a and 254-a extend into and out of the page in the view of FIG. 17. Antennas 252 and 254 may rotate about their respective axes 252-a and 254-a as satellite 200-1 moves along orbit 650 to maintain their respective communication paths with respective earth-based (or satellite-based) antennas with which they are communicating. Rotation about axes 252-a and 254-a corresponds to adjustment of the pitch angle of antennas 252 and 254, respectively. Rotation about axes 252-a and 254-a preferably enables satellite 200-1 to conduct communication with ground stations 100 present over a wide range of longitude over the surface of the earth 600. In some embodiments, antennas 252, 254 may also rotate about axis 256 which preferably enables satellite 200-1 to communicate with ground stations 100 at a range of different latitudes on the surface of the earth 600. Rotation about axis 256 corresponds to adjustment of the roll axis of antennas 252, 254.

It will be appreciated that rotation about axes 252-a/254-a and 256 does not necessarily correspond only to adjustment for longitude and latitude, respectively. In other words, in some embodiments, rotation about axis 256 by antenna 252 may change both the latitude and longitude of the location on the earth 600 with which antenna 252 communicates. Likewise, in some embodiments, rotation of antenna 252 about axis 252-a may change both the latitude and the longitude of the location on the earth 600 with which antenna 252 communicates.

In one embodiment, antenna 252 may communicate with a ground station 100, and antenna 254 may communicate with a gateway station 700, thereby connecting ground station 100 to a global communication network. However, in other embodiments, this arrangement may be varied. Although only two steerable antennas 252, 254 are shown in FIG. 17, any desired number of antennas may be employed on a given satellite 200-1. For example, the embodiment of FIG. 16 shows a satellite 200 with twelve customer dishes and two gateway dishes. In an embodiment, all fourteen dishes shown in FIG. 16 may be steerable antennas. In one embodiment, all fourteen antennas may be mechanically steerable. In other embodiments, all fourteen antennas may be electronically steerable. In yet other embodiments, a combination of mechanically steerable antennas and electronically steerable antennas may be included among the fourteen antennas shown in FIG. 16. Moreover, it will be appreciated that fewer or more than fourteen antennas may be included on one or more satellites 200 within satellite system 150.

FIG. 18 is a schematic representation of a satellite having two electronically steerable antennas 262, 264 in accordance with one or more embodiments of the present invention. In the embodiment of FIG. 18, antennas 262 and 264 may be continuously controlled to maintain respective communication paths with respective ground stations on the surface of the earth 600 and/or with other satellites, as satellite 200-1 proceeds along its orbit 650. In one embodiment, antenna 262 may communicate with a ground station 100 on the surface of the earth 600, and antenna 264 may communicate with a gateway station 700. While two phased array antennas are shown in FIG. 18, it will be appreciated that any number of antennas could be employed. Satellite 200-1 is not limited to having just one type of antenna. Specifically, satellite 200-1 could include one or more mechanically steerable antennas and/or one or more electronically steerable antennas (such as phased array antennas). As discussed in connection with FIG. 17, satellite 200 of FIG. 18 could include, for example, fourteen antennas as shown in FIG. 16, which include a mix of mechanically steerable antennas and electronically steerable antennas.

When operating in conjunction with a suitable tracking system (discussed in connection with FIG. 15), antenna 262 is preferably operable to adjust the direction of a communication path along one or more angular dimensions. Specifically, antenna 262 may adjust the pitch angle and/or the roll angle (both discussed in connection with FIG. 17) of a communication beam as needed.

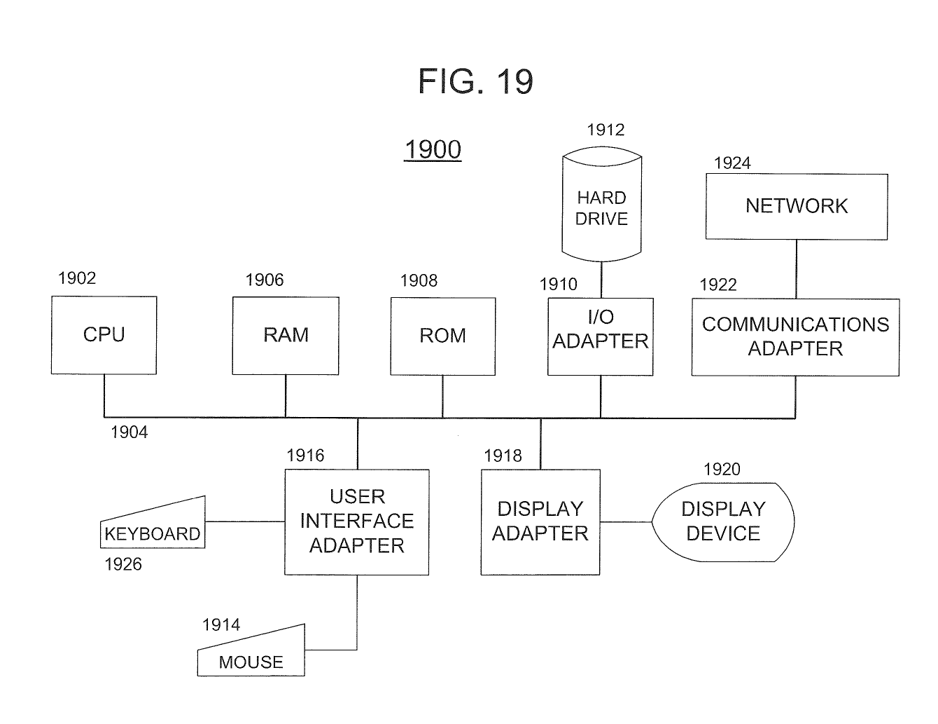

FIG. 19 is a block diagram of a computing system 1900 adaptable for use with one or more embodiments of the present invention. For example one or more portions of computing system 1900 may be employed to perform the functions of computing system 110 of FIGS. 3 and 3A, processor 302 and/or data path control 304 of FIG. 15, of gateway stations 700 discussed herein, and/or of one or more processing entities within communication system 10 of FIG. 1.

In one or more embodiments, central processing unit (CPU) 1902 may be coupled to bus 1904. In addition, bus 1904 may be coupled to random access memory (RAM) 1906, read only memory (ROM) 1908, input/output (I/O) adapter 1910, communications adapter 1922, user interface adapter 1906, and display adapter 1918.

In one or more embodiments, RAM 1906 and/or ROM 1908 may hold user data, system data, and/or programs. I/O adapter 1910 may connect storage devices, such as hard drive 1912, a CD-ROM (not shown), or other mass storage device to computing system 1900. Communications adapter 1922 may couple computing system 1900 to a local, wide-area, or global network 1924. User interface adapter 1916 may couple user input devices, such as keyboard 1926 and/or pointing device 1914, to computing system 1900. Moreover, display adapter 1918 may be driven by CPU 1902 to control the display on display device 1920. CPU 1902 may be any general purpose CPU.

It is noted that the methods and apparatus described thus far and/or described later in this document may be achieved utilizing any of the known technologies, such as standard digital circuitry, analog circuitry, any of the known processors that are operable to execute software and/or firmware programs, programmable digital devices or systems, programmable array logic devices, or any combination of the above. One or more embodiments of the invention may also be embodied in a software program for storage in a suitable storage medium and execution by a processing unit.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A satellite communications system, comprising:
a constellation of satellites operating in a substantially equatorial, non-geostationary orbit around the earth,
wherein at least one said satellite comprises:
a first antenna controllable to direct a first concentrated spot beam to at least one ground station;
a second antenna controllable to direct a second concentrated spot beam to at least one gateway ground station; and
a plurality of ground stations configured to communicate with said satellites, wherein at least one said ground station is configured to transfer communication connectivity away from a first satellite approaching a forbidden transmission range to a satellite in the constellation further from the forbidden transmission range.

2-4. (canceled)

5. The satellite communications system of claim 1 wherein the at least one satellite is operable to avoid interference with GEO satellite communication with a GEO sub-satellite point on the earth, by communicating with ground stations on the earth having a minimum latitudinal angular separation from the GEO sub-satellite point.

6. The satellite communications system of claim 5 wherein the minimum latitudinal angular separation is 5 degrees.

7. The satellite communications system of claim 1 wherein the system is operable to avoid impinging on the communication reception of any geostationary satellite as a result of said transfer of communication connectivity away from said first satellite.

8. The satellite communications system of claim 7 wherein the system maintains a minimum longitudinal angular separation of satellites in said constellation from a GEO sub-satellite point of 5 degrees.

9. The satellite communications system of claim 1 wherein a plurality of said satellites in said constellation are within a communication range of said ground station at any given time, thereby providing redundant satellite communication options for said ground station.

10. The satellite communications system of claim 9 wherein said ground station is operable to hand off communication from a first said satellite to a second said satellite in the event of a failure of said first satellite.

11-13. (canceled)

14. The satellite communications system of claim 1 wherein the at least one satellite is operable to route data packet signals to a destination within the communications system based on a transmission frequency of the data packet signal.

15. (canceled)

16. The satellite communications system of claim 1 wherein the constellation of satellites operates in an orbit having an altitude between 8,000 kilometers (km) and 20,000 km.

17. A method for communication, comprising:
causing a constellation of satellites to travel along a substantially equatorial, non-geostationary orbit;
controlling a first antenna aboard at least one said satellite to direct a first concentrated spot beam to at least one ground station;
controlling a second antenna on said at least one satellite to direct a second concentrated spot beam to at least one gateway station;
controlling a ground station in communication with at least of said satellites to transfer communication connectivity away from a first satellite approaching a forbidden transmission range to a satellite in the constellation further from the forbidden transmission range.

18. (canceled)

19. The method of claim 17 wherein the step of controlling the first antenna comprises at least one of:
a) mechanically steering the first antenna to direct the first concentrated spot beam to the at least one ground station; and
b) electronically steering the first concentrated spot beam.

20. The method of claim 17 wherein the step of controlling the second antenna comprises at least one of:
a) mechanically steering the second antenna to direct the second concentrated spot beam to the at least one ground station; and
b) electronically steering the second concentrated spot beam.

21. The satellite communications system of claim 17 wherein at least one of the first antenna and the second antenna is a phased array antenna.

22. The method of claim 17 further comprising:
avoiding impinging on the communication reception of any geostationary satellite as a result of said transfer of communication connectivity away from said first satellite.

23-25. (canceled)

26. A communications system, comprising:
a constellation of satellites operating in a substantially equatorial, non-geostationary orbit;
a plurality of ground stations configured to communicate with said satellites, at least one given ground station of said ground stations lacking a wired connection to any global communications network; and
at least one gateway station coupled to a global communications network and to at least one said satellite,
wherein each said satellite includes at least one antenna with a steerable beam controllable to continuously direct a first concentrated spot beam toward the given ground station;
wherein the system enables satellite-to-satellite communication thereby proving a redundant, failure-mode communication path in the event of a failure of a first customer dish on a first satellite, the redundant path extending from a first ground station to a second customer dish on said first satellite to any operational customer dish on a second satellite to a second ground station.

27. The communications system of claim 26 wherein the at least one antenna includes a mechanically steerable antenna.

28. The communications system of claim 26 wherein the at least one antenna includes a phased array antenna.

29. The system of claim 26 wherein each said satellite is operable to communicate simultaneously with said given ground station, and said at least one gateway station to enable connectivity between said given ground station and said global communications network.

30. The system of claim 29 wherein said global communications network includes the Internet.

31-33. (canceled)

34. The system of claim 26 wherein the orbit of said satellite constellation has an altitude of between 7,000 km and about 12,000 km.

35-39. (canceled)
